(19) United States
(12) Patent Application Publication
(10) Pub. No.: US 2024/0045350 A1
(43) Pub. Date: Feb. 8, 2024

(54) RESIN PARTICLE, TONER, DEVELOPING AGENT, TONER ACCOMMODATING UNIT, IMAGE FORMING APPARATUS, AND IMAGE FORMING METHOD

(71) Applicants: Toshihiko Sugiyama, Shizuoka (JP); Junichi Watanabe, Shizuoka (JP); Yuka Mizoguchi, Shizuoka (JP); Kazuoki Fuwa, Shizuoka (JP)

(72) Inventors: Toshihiko Sugiyama, Shizuoka (JP); Junichi Watanabe, Shizuoka (JP); Yuka Mizoguchi, Shizuoka (JP); Kazuoki Fuwa, Shizuoka (JP)

(73) Assignee: Ricoh Company, Ltd., Tokyo (JP)

(21) Appl. No.: 18/360,102

(22) Filed: Jul. 27, 2023

(30) Foreign Application Priority Data
Jul. 29, 2022 (JP) 2022-121879
Apr. 25, 2023 (JP) 2023-071653

(51) Int. Cl. G03G 9/087; C08G 63/183; C08G 18/10; C08G 18/42; C08G 18/75

(52) U.S. Cl. CPC G03G 9/08755; C08G 63/183; C08G 18/10; C08G 18/4225; C08G 18/755

(57) ABSTRACT

A resin particle contains a binder resin, wherein the resin particle has a loss tangent δ of 1.8 or greater at angular velocity of from 0.1 to 100 rad/s as measured by frequency sweep at 80 degrees C.

### CROSS-REFERENCE TO RELATED APPLICATIONS

This patent application is based on and claims priority pursuant to 35 U.S.C. § 119 to Japanese Patent Application Nos. 2022-121879 and 2023-071653, filed on Jul. 29, 2022, and Apr. 25, 2023, respectively, in the Japan Patent Office, the entire disclosures of which are hereby incorporated by reference herein.

### BACKGROUND

### Technical Field

The present disclosure relates to a resin particle, a toner, a developing agent, a toner accommodating unit, an image forming apparatus, and an image forming method.

### Description of the Related Art

Resin particles are widely used as the toner for image forming apparatuses such as multifunction peripherals and printers at offices and other sites. Toner is required to reduce the environmental burden during usage and manufacturing. Thus, toners with good low temperature fixability have been researched and developed to reduce the consumption power in fixing toner, leading to energy saving.

### SUMMARY

According to embodiments of the present disclosure, a resin particle is provided that contains a binder resin, wherein the resin particle has a loss tangent δ of 1.8 or greater at angular velocity of from 0.1 to 100 rad/s as measured by frequency sweep at 80 degrees C.

As another aspect of embodiments of the present disclosure, a toner is provided that contains the resin particle mentioned above.

As another aspect of embodiments of the present disclosure, a developing agent is provided that contains the toner mentioned above and a carrier.

As another aspect of embodiments of the present disclosure, a toner accommodating unit is provided that contains the toner mentioned above.

As another aspect of embodiments of the present disclosure, an image forming apparatus is provided that includes a latent electrostatic image bearer, a latent electrostatic image forming device to form a latent electrostatic image on the latent electrostatic image bearer, a developing device to develop the latent electrostatic image with the toner mentioned above to form a visible image, a transfer device to transfer the visible image to a printing medium, and a fixing device to fix the visible image transferred onto the printing medium.

As another aspect of embodiments of the present disclosure, an image forming method is provided that includes forming a latent electrostatic image on a latent electrostatic image bearer, developing the latent electrostatic image formed on the latent electrostatic image bearer with the toner mentioned above to form a visible image, transferring the visible image to a printing medium, and fixing the visible image transferred onto the printing medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a schematic configuration of the image forming apparatus according to an embodiment of the present invention;

FIG. 2 is a schematic diagram illustrating the image forming apparatus according to another embodiment of the present invention;

FIG. 3 is a schematic diagram illustrating the image forming apparatus according to another embodiment of the present invention;

FIG. 4 is a partially-enlarged diagram illustrating the image forming apparatus illustrated in FIG. 3; and

FIG. 5 is a diagram illustrating a schematic configuration of the process cartridge according to an embodiment of the present invention.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a resin particle is provided that demonstrates excellent low temperature fixability and color reproducibility.

Embodiments of the present disclosure are described in detail below. The embodiments of the present disclosure are not limited to the following descriptions and can be changed within the scope of the present disclosure. In the ranges of from a figure A to FIG. B in the present specification, the figure A and the figure B are both inclusive as the lower limit and the upper limit.

Resin Particle

The resin particle relating to the embodiments of the present invention are described below. The resin particle of the present embodiment contains a binder resin, wherein the resin particle has a loss factor or loss tangent δ of 1.8 or greater at an angular velocity of from to 100 rad/s as measured by a frequency sweep method at 80 degrees C.

As a result of an investigation about the resin particle used as toner for an image forming apparatus, the inventors of the present invention have found that viscoelasticity of the resin particles is affected by the temperature of a printing medium in the image forming apparatus when the printing medium is brought into contact with a pressing roller in the image forming apparatus and the angular velocity of the pressing roller. The inventors of the present invention have thus formulated a resin particle that demonstrates good low temperature fixability and color reproducibility if it has a loss tangent δ of 1.8 or greater at angular velocity of from 0.1 to 100 rad/s as measured by frequency sweep at 80 degrees C. of the resin particle.

The loss tangent δ means the ratio (G″/G′) of the loss elastic modulus G″ to the storage elastic modulus G′ obtained by measuring dynamic viscoelasticity. The storage elastic modulus G′ and the loss tangent δ are values measured with a dynamic viscoelasticity measuring device (rheometer, ARES, manufactured by TA Instruments). One way of measuring is to mold resin particles to a pellet having a diameter of 8 mm and a thickness of 2 mm, fix the pellet on a parallel plate having a diameter of 8 mm, and stabilize it at 80 degrees C. Next, the loss tangent δ is measured at an angular velocity of from 0.1 to 100 rad/s by frequency sweep under the condition of an amount of strain of 0.1 percent in the mode for controlling amount of strain.

The minimum temperature of the printing medium is expected to be about 80 degrees C. when the printing medium held in a feeder cassette of an image forming apparatus is brought into contact with the pressing roller of the image forming apparatus. The angular velocity of the pressing roller is expected to be in the range of from 0.1 to 100 rad/s. The resin particle of the present embodiment can enhance ducility of the resin particle during fixing and reduce the occurrence of cold offset when the loss tangent δ is 1.8 or greater at an angular velocity of from 0.1 to 100 rad/s as measured by frequency sweep at 80 degrees C. The resin particle of the present embodiment can thus be fixed at lower fixing temperatures and demonstrate a high level of coloring, so that the resin particle has excellent low temperature fixability and color reproducibility.

The loss tangent δ at an angular velocity of from 0.1 to 100 rad/s measured by frequency sweep at 80 degrees C. is preferably from 2.0 to 2.5, more preferably, 2.1 to 2.4, and furthermore preferably from 2.2 to 2.45.

For the resin particle of the present embodiment, the loss tangent δ at an angular velocity of from 0.1 to 100 rad/s measured by frequency sweep at 80 degrees C. of the resin particle preferably has an extremum. The resin particle of the present embodiment used as toner can enhance ducility at the expected minimum temperature, e.g., 80 degrees C., of the printing medium in contact with the roller during fixing if the resin particle has a loss tangent δ having an extremum. Therefore, the resin particle demonstrates good low temperature fixability or color reproducibility.

The extermum of the loss tangent δ includes both the local minimum and maximum.

The resin particle of the present embodiment preferably has a storage elastic modulus G′ of 1×10³ Pa or greater at measuring by dynamic viscoelasticity and also preferably has an extremum at 100 degrees C. or higher. The resin particle of the present embodiment can thus demonstrate more effect on low temperature fixability and enhance the degree of coloring, so that the resin particle demonstrates good low temperature fixability and color reproducibility.

The resin particle of the present embodiment preferably has a storage elastic modulus G′ having a local maximum at 100 degrees C. or higher. Because of this storage elastic modulus, the resin particle of the present embodiment can demonstrate a higher degree of coloring, thereby definitely demonstrating color reproducibility.

The resin particle of the present embodiment contains a mother particle, which can be a sole component of the resin particle.

The resin particle of the present embodiment contains a binder resin and may optionally contain other optional components.

Binder Resin

The binder resin for use in the resin particle of the present embodiment is not particularly limited. Preferably, it contains a crystalline resin or amorphous resin.

Crystalline Resin

The crystalline resin preferably contains crystalline polyester resin.

Crystalline Polyester Resin

The crystalline resin in the present embodiment includes a polymer with a 100 percent polyester structure and a copolymer of a monomer forming a polyester and other monomers. In the copolymer, the proportion of the other monomers is 50 percent by mass or less.

One way of obtaining the crystalline polyester resin for use in the resin particle of the present embodiment is to synthesize from a polycarboxylic acid and a polyhydric alcohol. The crystalline polyester resin can be procured or synthesized.

Specific examples of dicarboxylic acids include, but are not limited to: aliphatic dicarboxylic acid such as oxalic acid, maleic acid, fumaric acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, 1,18-octadecane dicarboxylic acid, and mesaconic acid; and aromatic dicarboxylic acids such as phthalic acid, isophthalic acid, terephthalic acid, naphthalene-2,6-dicarboxylic acid, malonic acid, trimellitic acid, and naphtalene dicarboxylic acid; alicyclic carboxylic acids such as cyclohexane dicarboxylic acid; anhydrides thereof; and lower alkyl esters thereof.

Specific examples of the tri- or higher carboxylic acids include, but are not limited to, pyromellitic acid, 1,2,4-benzene tricarboxylic acid, 1,2,5-benzene tricarboxylic acid, 1,2,4-naphtalene tricarboxylic acid, and their anhydrides or lower alkyl esters. These may be used alone or in a combination of two or more thereof. The polycarboxylic acid may include other carboxylic acids such as dicarboxylic acids having a sulfolanic acid group. Moreover, it may include a dicarboxylic acid having a double bond.

The polyhydric alcohol is preferably an aliphatic diol, more preferably a straight chain aliphatic diol having 7 to 20 carbon atoms in the main chain, and furthermore preferably a straight chain aliphatic diol having 14 or less carbon atoms at the main chain.

Such aliphatic diols degrade crystallinity of a crystalline polyester resin, thus lowering the melting point. An aliphatic diol having less than 7 carbon atoms in the main chain has a high melting temperature when condensation-polymerized with an aromatic diacrboxylic acid. This high melting temperature has an adverse impact on lower temperature fixing. An aliphatic diol having more than 20 carbon atoms in the main chain is not readily available.

Of the polyhydric alcohol, the proportion of the dialiphatic diol is preferably 80 mol percent or greater, and more preferably 90 mol percent or greater.

An aliphatic diol having a proportion of the aliphatic diol of lower than 80 mol percent lowers crystallinity of the crystalline polyester resin, which lowers the melting temperature. This melting temperature drop may degrade image storage stability and low temperature fixability.

Specific examples of the aliphatic diol include, but are not limited to: aliphatic diols such as ethylene glycol, diethylene glycol, triethylene glycol, 1,2-propanediol, 1,3-propanediol, 1,4-butanediol, 1,5-pentanediol, neopentyl glycol, 1,2-hexanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosandecanediol; alicyclic diols such as cyclohexane diol, cyclohexane dimethanol, and hydrogenated bisphenol A; and aromatic diols such as an adduct of bisphenol A with an ethylene oxide and an adduct of bisphenol A with a propylene oxide. Of these, 1,8-octane diol, 1,9-nonane diol, and 1,10-decane diol are preferable in terms of availability.

Polycarboxylic acids or polyalcohols can be optionally added in the last stage of synthesis to adjust the acid value or the hydroxyl value.

The crystalline polyester resin mentioned above can be manufactured at a polymerization temperature of from 180 to 230 degrees C. with optional processing such as reducing the pressure in a reaction system and removing water and alcohol produced during the condensation. It is suitable to add a solvent having a high boiling point as a dissolution helping solvent to dissolve a monomer if it is not dissolved or compatible at reactive temperatures.

The dissolution helping solvent is distilled away during the polycondensation reaction. For a poorly-compatible monomer in copolymerization reaction, it is suitable to condensate the poorly-compatible monomer with an acid or alcohol for polycondensation before polycondensation with the main components.

Examples of the catalysts used in manufacturing the crystalline polyester resin mentioned above include, but are not limited to, alkali metal compounds such as sodium, and lithium; alkali earth metal compounds such as magnesium and calcium; metal compounds such as zinc, manganese, antimony, titanium, tin, zirconium, and germanium; phosphorous acid compounds; phosphoric acid compounds; and amine compounds.

Specific examples include, but are not limited to, compounds such as sodium acetate, sodium carbonate, lithium acetate, lithium carbonate, calcium acetate, calcium stearate, magnesium acetate, zinc acetate, zinc stearate, zinc naphthenate, zinc chloride, manganese acetate, manganese naphthenate, titanium tetraethoxide, titanium tetrapropoxide, titanium tetraisopropoxide, titanium tetrabutoxide, antimony trioxide, triphenylantimony, tributylantimony, tin formate, tin oxalate, tetraphenyltin, dibutyltin dichloride, dibutyltin oxide, diphenyltin oxide, zirconium tetrabutoxide, zirconium naphthenate, zirconyl carbonate, zirconyl acetate, zirconyl stearate, zirconyl octylate, germanium oxide, triphenylphosphite, tris(2,4-di-t-butylphenyl) phosphite, ethyltriphenylphosphonium bromide, triethylamine, and triphenylamine. These crystalline polyester resins can be used alone or in combination.

Amorphous Resin

The amorphous resin preferably includes a non-crystalline (amorphous) polyester resin.

Non-Crystalline Polyester Resin

The non-crystalline polyester resin of the present embodiment includes a modified polyester resin and a non-modified polyester resin. Using both a modified polyester resin and a non-modified polyester resin is preferable.

Modified Polyester Resin

Examples of the modified polyester resin are as follows. An example of the modified polyester resin is a polyester prepolymer with an isocyanate group. The polyester prepolymer mentioned above can be prepared by, for example, reacting a polyester having an active hydrogen group, which is a polycondensation product of a polyol (1) and a polycarboxylic acid (2), with a polyisocyanate (3).

Specific examples of the active hydrogen group contained in the polyester mentioned above include, but are not limited to, a hydroxyl group (alcohol hydroxyl group and phenol hydroxyl group), an amino group, a carboxylic group, and a mercarpto group. Of these, an alcohol hydroxyl group is particularly preferable.

Specific examples of the polyol (1) include, but are not limited to, diol (1-1), triol or higher alcohol (1-2) and using diol (1-1) alone or a mixture of diol (1-1) with a minimum amount of triol or higher alcohol (1-2) is preferable.

Specific examples of the diol (1-1) include, but are not limited to, alkylene glycols (e.g., ethylene glycol, 1,2-propylene glycol, 1,3-propylene glycol, 1,4-butane diol, and 1,6-hexane diol); alkylene ether glycols (e.g., diethylene glycol, triethylene glycol, dipropylene glycol, polyethylene glycol, polypropylene glycol, and polytetra methylene ether glycol); alicyclic diols (e.g., 1,4-cyclohexane dimethanol, and hydrogen added bisphenol A); bisphenols (e.g., bisphenol A, bisphenol F and bisphenol S); adducts of the alicyclic diols mentioned above with an alklylene oxide (ethylene oxide, propylene oxide and butylenes oxide); and adducts of the bisphenols mentioned above with an alkylne oxide (ethylene oxide, propylene oxide and butylenes oxide). Of these, alkylene glycols having 2 to 12 carbon atoms and adducts of bisphenol with alkylene oxide are preferable. Adducts of bisphenol with alkylene oxide and mixtures thereof with alkylene glycol having 2 to 12 carbon atoms are particularly preferable.

Specific examples of the triol or higher alcohol (1-2) include, but are not limited to, aliphatic acid alcohols having three or more hydroxyl groups (e.g., glycerin, trimethylol ethane, trimethylol propane, pentaerythritol and sorbitol); polyphenols having three or more hydroxyl groups (trisphenol PA, phenol novolak, and cresol novolak); and adducts of the tri- or higher phenols mentioned above with an alkylene oxide.

Specific examples of polycarboxylic acids (2) include, but are not limited to, dicarboxylic acids (2-1) and polycarboxylic acids (2-2) having three or more carboxyl groups. Of these, using the dicarboxylic acid (2-1) alone or a mixture of the dicarboxylic acid (2-1) with a small amount of polycarboxylic acids (2-2) having three or more carboxyl groups is preferable.

Specific examples of the dicarboxylic acids (2-1) include, but are not limited to, alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid, and naphthalene dicarboxylic acid). Of these compounds, alkenylene dicarboxylic acids having 4 to 20 carbon atoms and aromatic dicarboxylic acids having 8 to 20 carbon atoms are preferable.

Specific examples of the polycarboxylic acids (2-2) having three or more carboxyl groups include, but are not limited to, aromatic polycarboxylic acids having 9 to 20 carbon atoms (e.g., trimellitic acid and pyrromellitic acid).

Anhydrides or lower alkyl esters (e.g., methyl esters, ethyl esters or isopropyl esters) of the polycarboxylic acids mentioned above can be used as the polycarboxylic acid (2).

A suitable mixing ratio (i.e., an equivalence ratio [OH]/[COOH]) of the polyol (1) to the polycarboxylic acid (2) is from 2/1 to 1/1, preferably from 1.5/1 to 1/1, and more preferably from 1.3/1 to 1.02/1.

Specific examples of the polyisocyanates (3) include, but are not limited to, aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisosycantes (e.g., tolylene diisocyanate and diphenylmethane diisocyanate); aromatic aliphatic diisocyanates (e.g., α,α,α′,α′-tetramethyl xylylene diisocyanate); isocyanurates; blocked polyisocyanates in which the polyisocyanates mentioned above are blocked with a substance such as a phenol derivative thereof, an oxime, or a caprolactam. These compounds can be used alone or in combination.

Suitable mixing ratio (i.e., [NCO]/[OH]) of a polyisocyanate (3) to a polyester having a hydroxyl group is from 5/1 to 1/1, preferably from 4/1 to 2/1 and more preferably from 2.5/1 to 1.5/1. When the [NCO]/[OH] ratio is greater than 5, low temperature fixability tends to deteriorate. When the molar ratio of [NCO] is less than 1, the urea content of urea-modified polyesters in the modified polyesters tends to be small, which leads to deterioration of hot offset resistance. The proportion of the constitutional component of the polyisocyanate (3) in the polyisocyanate group-terminated prepolymer (A) is from 0.5 to 40 percent by mass, preferably from 1 to 30 percent by mass, and more preferably from 2 to 20 percent by mass. A ratio of the polyisocyanate (3) of less than 0.5 percent degrades hot offset resistance and is disadvantageous to strie a balance between high temperature storage stability and low temperature fixability. In contrast, when the content ratio surpasses 40 percent, low temperature fixability deteriorates.

The number of isocyanate groups in the prepolymer (A) per molecule is normally not less than 1, preferably from 1.5 to 3, and more preferably from 1.8 to 2.5 on average. If the number of isocyanate groups is less than 1, the molecular weight of urea-modified polyester decreases and hot offset resistance readily deteriorates.

Non-Modified Polyester Resin

In the present embodiment, the non-modified polyester resin is preferably used as a non-crystalline polyester resin in combination with a modified polyester resin. Due to the combinational use of the non-modified polyester resin and the modified polyester resin, low temperature fixability and gloss and uniformity of gloss in the case that this combination is used for a full color image forming apparatus are enhanced.

The non-modified polyester resin includes a polycondensation product of the same polyester components of the polyol (1) and the polycarboxylic acid (2) as those for the modified polyester resin. The detail description is omitted because the same polyol (1) and polycarboxylic acid (2) as those for the above modified polyester resin can be used.

The non-modified polyester resin not only includes an unmodified polyester but also a polyester resin modified by bonding (e.g., urethane bonding) other than urea bonding. It is preferable that the non-modified polyester resin and the modified polyester resin be at least partially compatible in each other to enhance low temperature fixability and hot offset resistance. Therefore, the polyester component of the modified polyester resin preferably has a structure analogous to that of the non-modified polyester resin.

The mass ratio of the modified polyester resin to the non-modified polyester resin in the case that the modified polyester resin is contained is from 5/95 to 75/25, preferably from to 25/75, more preferably from 12/88 to 25/75, and particularly preferably from 12/88 to 22/78. A modified polyester resin having a mass ratio of less than 5 percent has poor hot offset resistance and is disadvantageous to strike a balance between high temperature storage stability and low temperature fixability.

The peak molecular weight of the non-modified polyester resin is from 1,000 to preferably from 1,500 to 10,000, and more preferably from 2,000 to 8,000. A non-modified polyester resin having a peak molecular weight of 1,000 or greater has sufficient high temperature storage stability. A non-modified polyester resin having a peak molecular weight of 10,000 or less has good low temperature fixability.

The non-modified polyester resin preferably has a hydroxyl value of 5 or more, more preferably from 10 to 120, and furthermore preferably from 20 to 80. A non-modified polyester resin having a hydroxyl value of 5 or greater is advantageous to strike a balance between high temperature preservability and low temperature fixability.

The acid value of the non-modified polyester resin is from 0.5 to 40 and preferably from 5 to 35. A non-modified polyester resin having such an acid value is likely to have negative chargeability.

A non-modified polyester resin having an acid value and a hydroxyl value within the preferable ranges specified above is not readily affected by the change in the environment in a high temperature and high humidity environment, thus keeping good image quality.

The resin particle of the present embodiment has a glass transition temperature Tg of from 40 to 70 degrees C. and preferably from 45 to 55 degrees C. A resin particle having a Tg of 40 degrees C. or higher has good high temperature storage stability. A resin particle having a Tg of 70 degrees C. or lower has good low temperature fixability. The resin particle of the present embodiment demonstrates good storage stability in comparison with a known polyester resin particle due to the presence of a resin obtained by cross-linking and/or elongating the prepolymer which is described later whether or not the resin particle has a low Tg.

The temperature Tg′ at which the resin particle of the present embodiment has a storage elastic modulus of 10,000 dyne/cm² at a measuring frequency of 20 Hz is 100 degrees C. or higher and preferably from 110 to 200 degrees C. In the case that the TG′ is lower than 100 degrees C., hot offset resistance deteriorates.

The temperature Tη at which the resin particle of the present embodiment has a viscosity of 1,000 poise at a measuring frequency of 20 Hz is 180 degrees C. or lower and preferably from 90 to 160 degrees C. Conversely, if the temperature Tri surpasses 180 degrees C., low temperature fixability deteriorates.

The temperature Tg′ is preferably higher than the temperature Tri to strike a balance between low temperature fixability and hot offset resistance. In another expression, the difference (Tg′-Tη) between the temperature Tg′ and the temperature Tη is preferably higher than 0 degrees C. It is more preferably 10 degrees C. or higher and furthermore preferably from 20 degrees C. or higher. This difference has no particular upper limit.

In addition, the difference (Tη-Tg) is preferably from 0 to 100 degrees C., more preferably from 10 to 90 degrees C., and furthermore preferably from 20 to 80 degrees C.

The acid value of the resin particle of the present embodiment is preferably 7 mg/g or greater to manufacture fine particles by phase inversion emulsification. The acid value is more preferably 30 mg/g for metal-cross-linking with an aggregated salt.

Reactive Precursor

The resin particle of the present embodiment may contain a reactive precursor (prepolymer). One of the prepolymers is a polyester resin (polyester resin (A)) with a group reactive with an active hydrogen group. The resin particle of the present embodiment using the polyester resin (A) as a reactive precursor has good low temperature fixability and color reproducibility.

Specific examples of the group reactive group with an active hydrogen group include, but are not limited to, an isocyanate group, an epoxy group, a carboxylic acid, and an acid chloride group. Of these, an isocyanate group is preferable to introduce a urethane or urea bond into an amorphous polyester resin.

The reactive precursor may have a branched structure attributed by at least one of tri- or higher alcohol and tri- or higher carboxylic acid.

One example of the polyester resin containing an isocyanate group is a reaction product of a polyisocyanate and a polyester resin with an active hydrogen group.

One way of obtaining a polyester resin with an active hydrogen group is to polycondense a diol with a dicarboxylic acid or a tri- or higher alcohol with a tri- or higher carboxylic acid.

A tri- or higher alcohol and a tri- or higher carboxylic acid provide a branched structure to a polyester resin with an isocyanate group.

Specific examples of the diols include, but are not limited to, aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol and 1,12-dodecanediol, diols having oxyalkylene groups such as diethylene glycol, triethylene glycol, dipropylene glycol, polyethylene glycol, polypropylene glycol and polytetramethylene glycol; diols having oxyalkylene groups such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; adducts of alicyclic diols with an alkylene oxide such as ethylene oxide, propylene oxide, and butylene oxide; bisphenols such as bisphenol A, bisphenol F, and bisphenol S; and adducts of bisphenols with an alkylene oxide such as ethylene oxide, propylene oxide, and butylene oxide. Of these, aliphatic diols having 3 to 10 carbon atoms such as 1,2-propylene glycol, 1,3-propylene glycol, 1,4-butanediol, 2-methyl-1,3-propanediol, 1,5-pentanediol, and 3-methyl-1,5-pentanediol are preferable to adjust the glass transition temperature of the polyester resin (A) to 20 degrees C. or lower. Using these aliphatic diol at a proportion of 50 percent by mol or greater to the alcohol components in a resin is more preferable. These diols can be used alone or in combination.

The polyester resin (A) is preferably an amorphous resin. A polyester resin (A) having a resin chain with steric hindrance has low melt viscosity at fixing due to steric effects in the resin chain, thus readily demonstrating low temperature fixability. Considering this preference, the main chain of an aliphatic diol preferably has the structure represented by the following Chemical Formula 1.

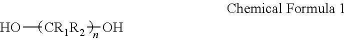

In the Chemical Formula 1, R₁ and R₂ each independently represent hydrogen atoms or alkyl groups with 1 to 3 carbon atoms and n represents an odd integer of from 3 to 9. R₁ and R₂ each independently can be the same or different in the n repeating units.

The main chain of an aliphatic diol refers to a carbon chain linked between the two hydroxy groups of the aliphatic diol with the minimal number. An odd number of carbon atoms in the main chain is preferable because it degrades crystallinity by parity. In addition, aliphatic diol with at least one alkyl group having 1 to 3 carbon atoms in the side chain is preferable, which decreases the mutual action energy between the molecules in the main chain because of steric conformation.

Specific examples of the dicarboxylic acids include, but are not limited to, aliphatic dicarboxylic acids such as succinic acid, adipic acid, sebacic acid, dodecanedioic acid, maleic acid, and fumaric acid and aromatic dicarboxylic acids such as phthalic acid, isophthalic acid, terephthalic acid, naphthalene dicarboxylic acids. In addition, their anhydrides, lower (i.e., 1 to 3 carbon atoms) alkyl esterified compound, and halogenated compounds can be used. Of these, aliphatic dicarboxylic acid with 4 to 12 carbon atoms is preferable and using 50 percent by mass or greater of the carboxylic acid component in a resin to achieve a glass transition temperature Tg of a polyester resin of 20 degrees C. or lower. These dicarboxylic acids can be used alone or in combination.

Specific examples of tri- or higher alcohols include, but are not limited to, tri- or higher aliphatic alcohols such as glycerin, trimethylolethane, trimethylolpropane, pentaerythritol, and sorbitol; tri- or higher polyphenols such as trisphenol PA, phenol novolac, and cresol novolac; and adducts of alkylene oxide such as ethylene oxide, propylene oxide, and butylene oxide with trihydric or higher polyphenols.

One example of tri- or higher carboxylic acids is a tri- or higher aromatic carboxylic acid. Tri- or higher aromatic carboxylic acids with 9 to 20 carbon atoms such as trimellitic acid and pyromellitic acid are preferable. In addition, their anhydrides, lower (i.e., 1 to 3 carbon atoms) alkyl esterified compound, and halogenated compounds can be used.

Examples of the polyisocyanate include, but are not limited to, diisocyanate and tri- or higher isocyanate.

The polyisocyante is not particularly limited and can be suitably selected to suit to a particular application.

Specific examples include, but are not limited to, aromatic diisocyanates such as either or both of 1,3- and 1,4-phenylene diisocyanate, of 2,4- and 2,6-tolylene diisocyanate (TDI), of crude TDI, of 2,4′- and 4,4′-diphenyl methane diisocyanate (MDI), and of crude MDI [phosgenated compounds of crude diamonophenyl methane (condensed product of formaldehyde and aromatic amine (aniline) or with a their mixture; a mixture of diaminodiphenyl methane and a small amount (e.g., 5 to 20 percent by mass) of tri- or higher polyamine]:polyallyl polyisocyanate (PAPI)], 1,5-naphtylene didsocyanate, 4,4′,4″-triphenylmethane triisocyanate, m- and p-isochyanato phenylsupphonyl isocyanate; aliphatic diisocyanates such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate; alicyclic diisocyanates such as isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate and 2,5- and 2,6-norbornane diisocyanate; aromatic aliphatic diisocyanates such as m- and p-xylylene diisocyanate (XDI) and α,α,α′,α′-tetramethylxylylene diisocyanate (TMXDI); tri- or higher polyisocyanates such as lysine triisocyanate and diisocyanate modified products of tri- or higher alcohols; and modified products of these isocyanates. Mixtures of two or more types mentioned above can be used.

Specific examples of the modified products of isocyanate include, but are not limited to, modified compounds having a urethane group, a carbodiimide group, an allophanate group, a urea group, a biuret group, a uretdione group, a uretonimine group, an isocyanulate group, or an oxazoline group.

The proportion of the reactive precursor is preferably from 1 to 20 percent by weight, preferably from 3 to 15 percent by weight, and more preferably from 5 to 10 percent by weight. A proportion of the reactive precursor of from 1 to 20 percent by weight enhances plasticity.

Other Optional Components

The resin particle of the present embodiment may optionally contain other components such as a flocculant, colorant, releasing agent (wax), charge control agent, external additive, and cleaning property improver.

Flocculant

Viscoelasticity of the resin particle of the present embodiment can be adjusted by the type of an aggregation agent to be added in the aggregation described later and the acid value of the polyester resin particle in the resin particle. Storage elastic modulus of the resin particle of the present embodiment is in proportion to the ratio of the salts of metal such as magnesium in the aggregated salts to the carboxyl group in the polyester resin particle in the resin particle. A high proportion of the metal salt to the carboxyl groups leads to an increase in viscoelasticity of the resin particle. This increase is inferentially explained by an increase in the cross-linking density caused by the metal cross-linking as a result of chelating between the carboxyl group with the magnesium ion as a polyvalent metal ion.

Compared with a method of adjusting viscoelasticity by covering the core resin with a Si shell utilizing suspension polymerization, the resin particle containing a flocculant can have a uniform viscoelasticity, thus stably demonstrating viscoelasticity.

The aggregated salt is preferably di- or higher valent metal salt and more preferably tri- or higher valent metal salt to have a sufficient cross-linking density.

Any known flocculant can be used. Examples include, but are not limited to, metal salts of monovalent metals such as sodium and potassium, metal salts of divalent metals such as calcium and magnesium, and metal salts of trivalent metals such as iron and aluminum.

Colorant

The colorant is not particularly limited and can be suitably selected to suit to a particular application. Specific examples include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red FSR, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone.

The proportion of the colorant is not particularly limited and can be suitably selected to suit to a particular application. The number of parts of the colorant is preferably from 1 to parts by mass and more preferably from 3 to 10 parts by mass to 100 parts by mass of the resin particle mentioned above.

The colorant can be used with a resin as a composite master batch.

Specific examples of the resins for use in manufacturing a master batch or the resins to be kneaded with a master batch include, but are not limited to, the amorphous polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-methyl chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, and paraffin waxes. These can be used alone or in combination.

The master batch can be prepared by mixing and kneading a resin and a coloring agent for master batch under high shear stress thereto. In this case, an organic solvent can be used to boost the interaction between the colorant and the resin. In the flushing method, an aqueous paste including water of a coloring agent is mixed with a resin and an organic solvent to transfer the coloring agent to the resin solution and then the aqueous liquid and organic solvent are removed. This method is preferably used because the resulting wet cake of the coloring agent can be used as it is. In this case, a high shear dispersion device such as a three-roll mill can be preferably used for kneading the mixture.

Releasing Agent

The releasing agent is not particularly limited. It can be suitably selected from the known monomers.

The releasing agent includes waxes.

Specific examples of such waxes include, but are not limited to, natural waxes including: vegetable waxes such as carnauba wax, cotton wax, Japan wax, and rice wax; animal waxes such as bee wax and lanolin; mineral waxes such as ozokerite; and petroleum waxes such as paraffin, microcrystalline, and petrolatum. In addition to these natural waxes, synthesis hydrocarbon waxes such as Fischer-Tropsch wax, polyethylene wax, and polypropylene and synthesis wax such as ester, ketone, and ether are also usable.

Furthermore, aliphatic acid amide such as 12-hydroxystearic acid amide, stearic acid amide, phthalic acid anhydride imide, and chlorinated hydrocarbons; crystalline polymer resins having a low molecular weight such as homo polymers, for example, poly-n-stearylic methacrylate and poly-n-lauryl methacrylate, and copolymers (for example, copolymers of n-stearyl acrylate-ethylmethacrylate); and crystalline polymer having a long alkyl group in the branched chain are also usable. Of these, the synthetic waxes are preferable and ester wax is more preferable to ensure dispersibility and charge stability. These can be used alone or in combination.

The melting point of the releasing agent is not particularly limited and can be suitably selected to suit to a particular application. It is preferably from 60 to 80 degrees C. A releasing agent having a melting point of 60 degrees C. or higher does not readily melt at low temperatures, thus being stable in storage. A releasing agent having a melting point of degrees C. or lower sufficiently melts and is free of fixing offset when the molten resin is within the fixing temperature range, which reduces image defects such as image deficiency.

Charge Control Agent

The charge control agent is not particularly limited and can be suitably selected to suit to a particular application.

Specific examples of the charge control agents include, but are not limited to, nigrosine dyes, triphenylmethane dyes, chrome containing metal complex dyes, chelate pigments of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing surfactants, metal salts of salicylic acid, and metal salts of salicylic acid derivatives.

Specific examples include, but are not limited to, BONTRON 03 (nigrosine dye), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, and a quaternary ammonium group.

The content of the charge control agent is not particularly limited and can be selected to suit to a particular application. The content of the charge control agent is preferably from 0.1 to 10 parts by mass and more preferably from 0.2 to 5 parts by mass to 100 parts by mass of the resin particle, for example. A resin particle containing a charge control agent in a proportion of 10 parts by mass or less does not have excessive charging size while the charge control agent maintains the effect. Therefore, the electrostatic attraction force between the resin particle and a developing roller does not become excessively large, keeping flowability of a developing agent and image density. These charge control agents can be melted and dispersed after they are melt-kneaded with a master batch and a resin. Alternatively, they can be directly added to an organic solvent to be dissolved or dispersed therein. Alternatively, they can be fixed on the surface of a resin particle after the resin particle is formed.

External Additive

The external additive is not particularly limited and can be suitably selected to suit to a particular application. The external additive includes, but is not limited to, an inorganic fine particle and polymer-based fine particle.

Specific examples of the inorganic fine particles include, but are not limited to, oxides such as silica, alumina, titanium oxide, iron oxide, copper oxide, zinc oxide, tin oxide, chromium oxide, cerium oxide, red iron oxide, antimony trioxide, magnesium oxide and zirconium oxide; titanium compounds such as barium titanate, magnesium titanate, calcium titanate and strontium titanate; silicides such as silica sand, clay, mica, wollastonite and diatomaceous earth; sulfides such as barium sulfate; carbonates such as barium carbonate and calcium carbonate; carbides such as silicon carbide; nitrides such as silicon nitride; and aliphatic acid metal salts such as zinc stearate and aluminum stearate. Of these, the oxides are preferable. Of the oxides, silica and titanium oxide are particularly preferable.

The number average primary particle diameter of the inorganic fine particles is not particularly limited and can be suitably selected to suit to a particular application. It is preferably 100 nm or less and more preferably from 3 to 70 nm.

An inorganic fine particle having a number average primary particle of 3 nm or greater does not bury in a resin particle and keep demonstrating its function. An inorganic fine particle having a number average primary particle of 100 nm or less does not readily damage the surface of a photoconductor unevenly.

One way of obtaining the average particle diameter is to directly measure the particle diameter from a photo taken with a transmission electron microscope (TEM). In another method, multiple, for example, 100 or more inorganic fine particles are visually checked to obtain the average major diameter.

The specific surface as measured by BET method is preferably from 20 to 500 m²/g.

The polymer-based fine particles include, but are not limited to, fluoropolymers, polystyrene, methacrylates, and acrylates obtained by soap-free emulsion polymerization, suspension polymerization, or dispersion polymerization, and polymer particles of thermal curing resin such as polycondensation resins such as silicone, benzoguanamine, and nylon.

The surface of the inorganic fine particles and polymer-based fine particles can be subjected to hydrophobic treatment with a hydrophobing agent.

One way of obtaining the hydrophobized inorganic fine particle is to hydrophobize the surface of hydrophilic inorganic fine particles with a hydrophobing agent such as a silane coupling agent such as methyltrimethoxysilane, methyltriethoxysilane, and octyltrimethoxysilane, a silane coupling agent having a fluorinated alkyl group, an organic titanate-based coupling agent, an aluminum-based coupling agent, a silylating agent, silicone oil, or modified silicone oil. The inorganic fine particles can be heated in the case that the inorganic fine particles are surface-treated with silicone oil. Hydrophobized silica, titania, or alumina can be used as suitable hydrophobized inorganic fine particle.

Specific examples of the silicone oils include, but are not limited to, dimethyl silicone oil, methylphenyl silicone oil, chlorophenyl silicone oil, methylhydrogene silicone oil, alkyl-modified silicone oil, fluorine-modified silicone oil, polyether-modified silicone oil, alcohol-modified silicone oil, amino-modified silicone oil, epoxy-modified silicone oil, epoxy/polyether silicone oil, phenol-modified silicone oil, carboxyl-modified silicone oil, mercapto-modified silicone oil, methacryl-modified silicone oil, and α-methylstyrene-modified silicone oil.

The primary particles of the hydrophobized inorganic fine particles preferably have an average particle diameter of from 1 to 100 nm and more preferably from 5 nm to 70 nm.

Hydrophobized polymer-based fine particles can be obtained by treating the surface with the hydrophobing agent mentioned above in the same manner as the hydrophobized inorganic fine particle.

The proportion of the external additive is not particularly limited and can be suitably selected to suit to a particular application. The number of parts by mass of the resin particle is preferably from 0.1 to 5 parts by mass and more preferably from 0.3 to 3 parts by mass to 100 parts by mass of the resin particle.

Method of Manufacturing Resin Particle

The method of manufacturing the resin particle of the present embodiment is described below. The method of manufacturing the resin particle of the present embodiment includes preparing an oil phase, preparing an aqueous phase, phase inversion emulsifying, solvent-removing, aggregating, and fusing. The method may include other optional processes such as shelling, rinsing, drying, annealing, and adding an external additive.

Preparing Oil Phase

In the method of manufacturing the resin particle of the present embodiment, an oil phase is prepared first in which components such as a binder resin, colorant containing an isoindoline skeleton-based pigment, cross-linking component, and wax are dissolved or dispersed in an organic solvent.

A specific method of preparing an oil phase is to slowly add a binder resin, a colorant containing an isoindoline skeleton-based pigment, a cross-linking component, and wax to an organic solvent during stirring to dissolve or disperse in the solvent. For dispersion, known devices such as a bead mill or disk mill can be used.

Each of the materials in preparing an oil phase can be each constituent component of the resin particle of the present embodiment. These can be used alone or in combination. A charge control agent can be added to this oil phase.

Organic Solvent

The organic solvent is not particularly limited and can be suitably selected to suit to a particular application. It is preferably a volatile solvent having a boiling point of lower than 100 degrees C. to remove the organic solvent later.

Specific examples of the organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone, methylisobuthyl ketone, methanol, ethanol, and isopropyl alcohol. These can be used alone or in combination. It is preferable to dissolve or disperse a resin with a polyester backbone in an organic solvent such as ester-based solvents including methyl acetate, ethyl acetate, and butyl acetate or ketone-based solvents including methylethyl ketone and methyl isobutyl ketone because the resin is well dissolved or dispersed in these solvents. Of these, methyl acetate, ethyl acetate, and methyl ethyl ketone are particularly preferable to readily purge a dispersion of the organic solvent later.

Preparing Aqueous Phase

An aqueous phase (aqueous medium) is prepared in preparing an aqueous phase.

The aqueous medium is not particularly limited and can be suitably selected among known media to suit to a particular application. It includes, for example, water, a solvent miscible with water, and a mixture thereof.

The solvent miscible with water is not particularly limited and can be suitably selected among known solvents to suit to a particular application. It includes, for example, alcohol, dimethyl formamide, tetrahydrofuran, cellosolves, lower ketones, and esters.

Specific examples of the alcohols include, but are not limited to, methanol, isopropanol, and ethylene glycol.

Specific examples of the lower ketones include, but are not limited to, acetone and methyl ethyl ketone.

A specific example of the esters is ethyl acetate.

These can be used alone or in combination.

Phase Inversion Emulsifying

The oil phase obtained in preparing an oil phase is atomized.

Deionized water is added to obtain a colored fine particle liquid dispersion by phase inversion emulsification in which this water-in-oil liquid dispersion, the oil phase neutralized with an alkali such as sodium hydroxide or ammonium water, to an oil-in-water liquid dispersion.

For phase inversion emulsification, a stirring blade can be used.

The stirring blade is not particularly limited and can be suitably selected according to viscosity of a solution. Examples thereof include, but are not limited to, low-viscosity stirring blades such as a paddle and a propeller, medium-viscosity stirring blades such as an anchor and a maxblend, and high-viscosity stirring blades such as a helical ribbon. Of these, paddles and anchors are preferable to adjust the volume average particle diameter of a liquid dispersion (oil droplet) to the preferable range mentioned above.

In the case that a stirring blade is used, conditions such as the number of revolutions, stirring time, and stirring temperature are not particularly limited and can be suitably selected to suit to a particular application.

The number of rotations is not particularly limited and preferably 100 to 1,000 rotation per minute (rpm) and more preferably from 200 to 600 rpm.

The stirring time and the stirring temperature are not particularly limited and can be suitably selected to suit to a particular application.

Optionally, it is possible to use a dispersant. The dispersant is not particularly limited and any known dispersion agent can be suitably used.

Specific examples include, but are not limited to, surfactants, inorganic compound dispersants sparingly soluble in water, and polymeric protective colloids. These can be used alone or in combination. Of these, surfactants are preferable.

The surfactant mentioned above has no particular limit and can be suitably selected to suit to a particular application. For example, anionic surfactants, nonionic surfactants, cationic surfactants, and amphoteric surfactants are usable.

The anionic surfactant is not particularly limited and can be suitably selected to suit to a particular application. Specific examples include, but are not limited to, alkylbenzene sulfonates, α-olefin sulfonates, and phosphate esters. Of these, compounds having a fluoroalkyl group are preferable.

Removing Solvent

In the solvent removal, the organic solvent is removed from the obtained colored fine particle dispersion.

One way of removing the organic solvent from the thus-prepared liquid dispersion of fine particles is to completely evaporate and remove the organic solvent in liquid droplets by gradually raising the temperature of the entire system during stirring.

Another way is to spray the obtained colored fine particle dispersion in a dried atmosphere during stirring to completely remove the organic solvent in droplets. Alternatively, it is possible to stir the colored fine particle dispersion under a reduced pressure to evaporate and remove the organic solvent.

These ways of removing the organic solvent can be conducted alone or in combination.

The dried atmosphere into which the colored fine particle dispersion is sprayed is obtained by heating air, nitrogen, carbon dioxide gas, and combustion gases. The air stream heated to temperatures higher than the highest boiling point of all of the solvents in the emulsion dispersion is normally used. The desired quality can be achieved by short-time treatment with a device such as a spray dryer, a belt dryer, and a rotary kiln.

The colored fine particle liquid dispersion can be obtained by removing the organic solvent from the obtained colored fine particle dispersion by the method described above.

Aggregation

The colored fine particle liquid dispersion obtained is stirred to obtain aggregated particles having a target particle size.

For aggregation, a known method is employed such as adding a flocculant and adjusting pH. Such a flocculant can be added as it is. However, an aqueous solution containing a flocculant is preferable to avoid a locally-high concentration. In addition, it is preferable to slowly add a flocculant while the particle diameter of fine particles is monitored.

The temperature of the liquid dispersion during aggregation is preferably close to the Tg of a resin to be used. An extremely low temperature of the colored fine particle liquid dispersion slows down aggregation, resulting in poor efficiency. An extremely high temperature accelerates aggregation, producing coarse particles. These coarse particles degrade particle size distribution.

Aggregation is caused to stop when the particle size reaches a target. Aggregation can be stopped by adding a low ion-valence salt or chelate agent, adjusting pH, lowering the temperature of a liquid dispersion, or decreasing the concentration with much amount of an aqueous medium.

The liquid dispersion containing colored aggregated particles is obtained by the methods described above.

In the aggregation, it is possible to add wax as a releasing agent or a crystalline resin for enhancing low temperature fixability. In this case, by aggregating a liquid dispersion in which wax is dispersed in an aqueous medium or after mixing with a colored fine particle liquid dispersion, aggregated particles in which wax or a crystalline resin are uniformly dispersed are obtained.

Fusing

The aggregated particles obtained are fused by heating to reduce rough particles, thus increasing spheroidized particles. To fuse the aggregated particles, the colored liquid dispersion of the colored aggregated particle is heated during stirring. A colored resin particle liquid dispersion is thus obtained. The liquid temperature is preferably around the Tg of a resin used.

Rinsing and Drying

The colored resin particles alone are taken out from the liquid dispersion of colored aggregated particles obtained by the method described above followed by rinsing and drying.

Rinsing

The colored liquid dispersion of the colored aggregated particles obtained by the method described above contains auxiliary materials such as a flocculant other than the colored aggregated particles. The colored liquid dispersion is rinsed to extract the colored aggregated particles alone.

The colored aggregated particles are rinsed by any method including centrifugal, filtering under a reduced pressure, and filter-pressing. Cakes of colored aggregated particles can be obtained by any of the methods. In the case that the colored aggregated particles are not rinsed sufficiently by one cycle of rinsing, the cake obtained is again dispersed in an aqueous solvent to obtain a slurry followed by repeating extracting the colored aggregated particles by any of the methods mentioned above. Alternatively, if filtering under a reduced pressure or filter-pressing is employed, it is possible to rinse off the auxiliary materials in the colored resin particles by passing an aqueous solvent through the cake.

The aqueous medium for use in rinsing is water or a solvent mixture of water with alcohol such as methanol and ethanol. Of these, water is preferable to reduce costs and the environmental burden resulting from wastewater treatment.

Drying

Since the resin particles after rinsing hold much amount of the aqueous medium inside, the colored resin particles are dried to remove the aqueous medium to obtain the colored resin particles alone.

To dry the colored resin particles, it is possible to use a drier such as a spray drier, vacuum freeze drier, a reduced-pressure drier, ventilation rack drier, mobile rack drier, fluid bed drier, rotary drier, and stirring drier.

The resin particle dried is preferably further dried until the moisture in the particle is less than 1 percent.

The colored resin particles after drying softly agglomerate. If this softly-aggregated particle is inadequate for use, it is suitable to pulverize the particle with a device such as a jet mill, Henschel mixer, super mixer, coffee mill, Oster blender, and food processor to loosen the softly agglomerated particle.

Annealing

In the case that a crystalline resin is added in the aggregation, the aggregated resin is subjected to annealing after drying, the non-crystalline resin and crystalline resin are phase-separated, thus enhancing fixability.

Specifically, the resin annealed is stored at around the Tg for 10 or more hours.

Adding External Additive

Optional components such as an external additive and cleaning improver are admixed with the obtained colored resin particle to impart properties such as flowability, chargeability, and cleanability.

Such optional components can be admixed by applying an impact to a mixture with a blade rotating at a high speed or placing a mixture into a jet air to collide particles against each other or composite particles to a collision board.

Specific examples of such devices for admixing include, but are not limited to, ONG MILL (manufactured by HOSOKAWA MICRON CO., LTD.), modified I TYPE MILL (manufactured by Nippon Pneumatic Mfg. Co., Ltd.) in which the air pressure of pulverization is reduced, HYBRIDIZATION SYSTEM (manufactured by NARA MACHINE CO., LTD.), KRYPTRON SYSTEM (manufactured by KAWASAKI HEAVY IUDUSTRIES, LTD.), and automatic mortars.

As described above, the method of manufacturing the resin particle of the present embodiment includes preparing an oil phase, preparing an aqueous phase, phase inversion emulsifying, solvent-removing, aggregating, and fusing, and optionally shelling, rinsing, drying, annealing, and adding an external additive to obtain the resin particle of the present embodiment.

As described above, the resin particle of the present embodiment has a loss tangent δ of 1.8 or greater at an angular velocity of from 0.1 to 100 rad/s as measured by frequency sweep at 80 degrees C. Due to this loss tangent δ, the resin particle of the present embodiment demonstrates low temperature fixability and color reproducibility, so that quality images can be provided.

The toner of the present embodiment has properties as described above, so that the toner can be used as a material for image forming such as a toner, a developing agent, a toner accommodating unit, and an image forming apparatus.

Toner

The toner of the present embodiment contains the resin particle relating to the present embodiment and can be formed of the resin particle relating to the present embodiment.

The toner of the present embodiment contains the resin particle relating to the present embodiment. The toner can thus demonstrate low temperature fixability and color reproducibility, so that quality images can be provided.

Development Agent

The developing agent of the present disclosure contains the toner relating to the present disclosure and other optional components such as a carrier. Due to these components, the developing agent of the present embodiment demonstrates low temperature fixability and color reproducibility, so that quality images can be stably provided.

The developing agent can be a one-component developing agent or a two-component developing agent. In the case that the developing agent used in a high-performance printer that supports high speed information processing of late, a two-component developing agent is preferable to enjoy a longer working life.

In the case that the toner of the present embodiment is used as a one-component developing agent, the developing agent demonstrates low temperature fixability and color reproducibility, so that quality images can be stably provided.

In the case that the toner relating to the present embodiment is used as a two-component developing agent, it is mixed with a carrier. Even in the case that the toner of the present embodiment is used as a two-component developing agent, the developing agent demonstrates excellent low temperature fixability and color reproducibility, so that quality images can be stably provided.

The content of the carrier in a two-component developing agent can be suitably selected to suit to a particular application. The content is preferably from 90 to 98 parts by mass and more preferably from 93 to 97 parts by mass to 100 parts of a two-component developing agent.

The developing agent of the present embodiment can be suitably used for image formation by various known electrophotography such as a magnetic one-component developing method, a non-magnetic one-component developing method, and a two-component developing method.

Carrier

The carrier is not particularly limited and can be suitably selected to suit to a particular application. Preferably, a carrier contains a core material and a resin layer (cover layer) covering the core material.

Core Material

The material of the core material is not particularly limited and can be suitably selected to suit to a particular application.

Specific examples include, but are not limited to, a manganese-strontium-based material of from 50 to 90 emu/g and a manganese-magnesium-based material of from 50 to 90 emu/g. To achieve a suitable image density, using a high magnetized material such as powdered iron not less than 100 emu/g and magnetite from 75 to 120 emu/g, is preferable. Low magnetized materials such as copper-zinc based material having 30 to 80 emu/g are preferable because it can reduce an impact of the developing agent in a filament state on a photoconductor and is advantageous to enhance the image quality. These can be used alone or in combination.

The volume average particle diameter of the core material is not particularly limited and can be suitably selected to suit a particular application. It is preferably 10 to 150 μm and more preferably from 40 to 100 μm. A volume average particle diameter of 10 μm or greater does not cause a problem of carrier scattering unlike finely-powdered carrier particles that scatters because of its low magnetization per particle. A volume average particle diameter of 150 μm or less prevents a problem of toner scattering resulting from a decreased specific surface area, which leads to degrading representation of a solid portion especially in full color printing with many solid portions.

Resin Layer

The materials for the resin layer is not particularly limited and can be suitably selected among known resins. Examples include, but are not limited to, amino resins, polyvinyl resins, polystyrene resins, polyhalogenated olefin, polyester resins, polycarbonate resins, polyethylene, polyfluoro vinyl, polyfluoro vinylidene, polytrifluoroethylene, polyhexafluoropropylene, a copolymer of polyfluoro vinylidene and an acryl monomer, a copolymer of polyfluoro vinyl and polyfluoro vinylidene, fluoroterpolymers such as a copolymer of tetrafluoroethylene, fluorovinylidene and a monomer including no fluorine atom, and silicone resins. These can be used alone or in combination.

The amino resin is not particularly limited and can be suitably selected to suit to a particular application.

Specific examples include, but are not limited to, urea-formaldehyde resins, melamine resins, benzoguanamine resins, urea resins, polyamide resins, and epoxy resins.

The polyvinyl resin is not particularly limited and can be suitably selected to suit to a particular application.

Specific examples include, but are not limited to, acrylic resins, polymethyl methacrylate resins, polyacrylonitrile resins, polyvinyl acetate resins, polyvinyl alcohol resins, and polyvinyl butyral resins.

The polystyrene resin is not particularly limited and can be suitably selected to suit to a particular application.

Specific examples include, but are not limited to, polystyrene and a styrene-acrylic copolymer.

The polyhalogenated olefin is not particularly limited and can be suitably selected to suit to a particular application. An example is polyvinyl chloride.

The polyester resin is not particularly limited and can be suitably selected to suit to a particular application.

Specific examples include, but are not limited to, polyethylene terephthalate and polybutylene terephthalate.

The resin layer optionally contains electroconductive powder.

The electroconductive powder is not particularly limited and can be suitably selected to suit to a particular application. Specific examples include, but are not limited to, powdered metal, carbon black, titanium oxide, tin oxide, and zinc oxide. The average particle diameter of such electroconductive powder is preferably 1 μm or less. The electric resistance of electroconductive powder having an average particle diameter of 1 μm or less can be adjusted.

The resin layer described above can be formed by dissolving a substance such as a silicone resin in a solvent to prepare a liquid application and applying the liquid application to the surface of the core material described above by a known application method followed by drying and baking.

The application method is not particularly limited and can be suitably selected to suit to a particular application.

Specific examples include, but are not limited to, dip coating, spraying, applying with a brush.

The solvent is not particularly limited and can be suitably selected to suit to a particular application.

Specific examples include, but are not limited to, toluene, xylene, methylethyl ketone, methylisobutyll ketone, and butylcellosolve acetate.

An external or internal heating system can be used for baking. For example, a fixed electric furnace, a fluid electric furnace, a rotary electric furnace, a method of using a burner furnace, and a method of using a microwave can be suitably used.

The content of the resin layer in a carrier is not particularly limited and can be suitably selected to suit to a particular application. The content is preferably 0.01 to 5.0 percent by mass. A resin layer having a content of 0.01 percent by mass or greater can form a uniform resin layer on the surface of a core material. A resin layer having a content of 5.0 percent by mass or less has a moderate thickness, so that carrier particles are inhibited from fusing, maintaining uniformity of the carrier.

Developing Agent Accommodating Unit

The developing agent relating to the present embodiment accommodates the developing agent relating to the present embodiment. The developing agent container is not particularly limited and can be suitably selected from known containers. One of them is a container with a cap.

The size, shape, structure, and materials of the container are not particularly limited. The shape is preferably cylindric. It is particularly preferable that spiral irregularities be formed on the inner peripheral surface, the developing agent as the content can move to the ejection port by rotation, and all or part of the spiral irregularities have a bellows function. Further, the material is not particularly limited, but preferably has good dimensional accuracy. Specific examples include, but are not limited to, resin materials such as polyester resin, polyethylene resin, polypropylene resin, polystyrene resin, polyvinyl chloride resin, polyacrylic acid, polycarbonate resin, ABS resin, and polyacetal resin.

The developing agent container is stored and conveyed with a handle of ease and can be detachably attached to an ink cartridge and an image forming apparatus, which are described later, to replenish the accommodating unit.

Toner Accommodating Unit

The toner accommodating unit relating to the present embodiment can accommodate the toner relating to the present embodiment. The toner accommodating unit relating to the present disclosure contains toner in a unit capable of accommodating the toner. Examples of the toner accommodating unit include, but are not limited to, a toner accommodating container (container containing toner), a developing unit, and a process cartridge.

The toner accommodating container is a container containing a toner.

The developing unit accommodates toner and develops an image with the toner.

The process cartridge integrally includes at least a latent electrostatic image bearer (also referred to as an image bearer) and a developing device, accommodates toner, and is detachably attachable to an image forming apparatus. The process cartridge may further include at least one member selected from the group consisting of a charger, an exposure, and a cleaning device.

Process Cartridge

The process cartridge relating to the present disclosure is molded to be detachably attachable to an image forming apparatus. It includes at least a latent electrostatic image bearer, a developing device that renders the latent electrostatic image borne on the latent electrostatic image bearer visible with the developing agent relating to the present disclosure to form a toner image, and other optional configurations.

The latent electrostatic image bearer is the same as that of the image forming apparatus, which is described later. Its detailed description is omitted.

The developing device includes a developing agent container that contains the developing agent of the present embodiment and a developing agent bearer that bears and conveys the developing agent in the developing agent container. The developing device may furthermore optionally include a member such as a regulating member for regulating the thickness of the developing agent borne on an image bearer.

The toner accommodating unit relating to the present embodiment contains the toner relating to the present embodiment and the toner relating to the present embodiment demonstrates excellent low temperature fixability and color reproducibility. The toner accommodating unit relating to the present embodiment is mounted onto an image forming apparatus. The image forming apparatus can produce quality images with the toner of the present embodiment having excellent low temperature fixability and color reproducibility.

Image Forming Apparatus

The image forming apparatus relating to the present disclosure includes a latent electrostatic image bearer, a latent electrostatic image forming device for forming a latent electrostatic image on the latent electrostatic image bearer, a developing device for developing the latent electrostatic image bearer on the latent electrostatic image bearer with toner, and other optional configurations.

The image forming apparatus relating to the present embodiment more preferably includes a transfer device for transferring the visible image to a printing medium and a fixing device for fixing the visible image transferred onto the surface of the printing medium in addition to the latent electrostatic image bearer, the latent electrostatic image forming device, and the developing device mentioned above.

The toner relating to the present embodiment is used in the developing device. It is preferable to use a developing device containing the toner relating to the toner and optionally other components such as a carrier to form a toner image.

Latent Electrostatic Image Bearing Member

The material, form, structure, and size of the latent electrostatic image bearer (also referred to as electrophotographic photoconductor or photocondcutor) are not particularly limited and can be selected among known devices. Specific examples of the materials include, but are not limited to, inorganic compounds such as amorphous silicon and selenium and organic compounds such as polysilane and phthalopolymethine. Of these, amorphous silicone is preferable to enjoy a long working life and an organic photoconductor (OPC) is preferable to produce a high definition image.

As an amorphous photoconductor, a photoconductor having a a-Si photoconductive layer can be used which is formed by heating a substrate at 50 to 400 degrees C. followed by film-forming utilizing a film-forming method such as a vacuum deposition method, a sputtering method, an ion-plating method, a thermal chemical vapor deposition (CVD) method, optical CVD method, and plasm CVD method. Of these, the plasma CVD method is preferable in which a material gas is decomposed by a direct current, high-frequency, or a microwave glow discharging to form an accumulated film of a-Si on a substrate.

The latent electrostatic image bearer is not particularly limited and can be suitably selected to suit to a particular application. A latent electrostatic image bearer having a cylinder-like form is preferable. The outer diameter of a photoconductor having a cylinder-like form is not particularly limited and can be suitably selected to suit to a particular application. It is preferably from 3 to 100 mm, more preferably from 5 to 50 mm, and particularly preferably from 10 to 30 mm.

The linear speed of a latent electrostatic image bearer is preferably at least 300 mm/s.

Latent Electrostatic Image Forming Device

The latent electrostatic image forming device is not particularly limited and can be suitably selected to suit to a particular application as long as it can form a latent electrostatic image on the latent electrostatic image bearer. The latent electrostatic image forming device includes, for example, at least a charging member as a charger to uniformly charge the surface of the latent electrostatic image bearer and an irradiating device as an irradiator to irradiate the surface of the latent electrostatic image bearer with light according to the obtained image information.

The charger is not particularly limited and can be suitably selected to suit to a particular application.

Specific examples include, but are not limited to, a contact type charger such as an electroconductive or semiconductive roll, brush, film, or a rubber blade, and a non-contact type charger utilizing corona discharging such as corotron or scorotron.

The charger may employ any form other than the roller, for example, a magnetic brush, and a fur brush and can be selected according to the specification or form of an image forming apparatus.

Preferably, the charger is disposed in contact or non-contact with the latent electrostatic image bearer and applies a direct voltage and an alternating voltage superimposed thereon to the surface of the latent electrostatic image bearer. The charger is preferably a charging roller disposed in contact with the latent electrostatic image bearer with a gap tape therebetween. It is preferable that the charging roller apply a direct voltage on which an alternate voltage is superimposed to charge the surface of the latent electrostatic image bearer.

The charger is not particularly limited to the contact type charging device but is preferable because such a charger contributes to manufacturing an image forming apparatus producing less amount of ozone.

The irradiator is not particularly limited and can be suitably selected to suit to a particular application as long as it can irradiate the surface of a latent electrostatic image bearer charged with a charger according to image information.

Specific examples of such irradiators include, but are not limited to, a photocopying optical system, a rod lens array system, a laser optical system, and a liquid crystal shutter optical system.

The light source for use in the irradiator is not particularly limited and can be suitably selected to suit to a particular application.

Specific examples include, but are not limited to, typical luminous materials such as a fluorescent lamp, a tungsten lamp, a halogen lamp, a mercury lamp, a sodium lamp, a light emitting diode (LED), a semiconductor laser (LD), and electroluminescence (EL).

Variety of optical filters can be used to irradiate a photoconductor with beams of light having only a desired wavelength.

For example, a sharp cut filter, a band-pass filter, a near infrared filter, a dichroic filter, a coherent filter, and a color conversion filter are suitably used.

The irradiator may irradiate a latent electrostatic image bearer from the rear side of the latent electrostatic image bearer according to image information.

Developing Device

The developing device is not particular limited and can be suitably selected to suit to a particular application as long as it can develop a latent electrostatic image formed on a latent electrostatic image bearer to render the image visible. The developing device preferably includes, for example, a developing unit for applying toner to a latent electrostatic image in a contact or non-contact manner. The developing unit preferably includes a container containing the toner.

In addition, the developing unit may be a single color or multi-color developing device. Preferably, the developing unit includes a stirrer for triboelectricaly charging toner, a magnetic field generator fixed inside, and a developing agent bearer, e.g., a magnet roller, rotatable while bearing a developing agent on its surface.

Transfer Device

The transfer device preferably includes a primary transfer device for transferring visible images to an intermediate transfer body to form a complex transfer image and a secondary transfer device for transferring the complex transfer image to a printing medium. The intermediate transfer body is not particularly limited and can be suitably selected from the known transfer members. One of the intermediate transfer bodies is a transfer belt.

The transfer device (the primary transfer device and the secondary transfer device mentioned above) preferably includes a transfer unit for peeling-charge the visible image formed on the latent electrostatic image bearer or photoconductor to peel it to the printing medium. One or more transfer devices can be provided.

Specific examples of the transfer units include, but are not limited to, a corona transfer unit employing corona discharging, a transfer belt, a transfer roller, a pressure transfer roller, and an adhesive transfer unit.

The printing medium is typically plain paper but any known printing paper to which a non-fixed image after development is transferred can be suitably used without particular limitation. It includes a PET base for an overhead projector.

Fixing Device

Any fixing device can be suitably selected without particular limitation to suit to a particular application. Any known heating and pressing device can be used. As the heating and pressing device, for example, a combination of a heating roller and a pressing roller or a combination of a heating roller, a pressing roller, and an endless belt can be suitably used.

For example, a preferable fixing device includes a heating body including a heat-generating member, a film in contact with the heating body, and a pressing member for pressing the heating body via the film to fix an un-fixed image on a printing medium while the printing medium passes between the film and the pressing member.

The heating temperature at the heating and pressing device is preferably from 80 to 200 degrees C.

The surface pressure at the heating and pressing device is not particularly limited and can be suitably selected to suit to a particular application. Preferably, it is from 10 to 80 N/cm².

In the present embodiment, a device such as an optical fixing device can be used together with or instead of the fixing device.

Other

The image forming apparatus may optionally furthermore include other devices such as a discharging (quenching) device, a recycling device, and a control device.

Discharging Device

The discharging device is not particularly limited as long as it can apply a discharging bias to a latent electrostatic image bearer. It can be selected among the known discharging devices. One of them is a discharging lamp.

Cleaning Device

Any known cleaner can be suitably used as the cleaning device as long as it can remove toner remaining on a latent electrostatic image bearer.

Specific examples of the cleaning device include, but are not limited to, a magnetic brush cleaner, an electrostatic brush cleaner, a magnetic roller cleaner, a blade cleaner, a brush cleaner, and a web cleaner.

The image forming apparatus can enhance cleanability due to the cleaning device included in the image forming apparatus. Cleanability is enhanced because flowability of toner is maintained by controlling the attachment force between toner particles. In addition, due to controlling the properties of degraded toner, the cleaning performance is maintained good to achieve a long-working life even in a severe condition such as a high temperature and moisture environment. Moreover, since the external additive can be sufficiently isolated from the toner on a photoconductor, an accumulating layer, a dam layer, of the external additive at the cleaning blade nipping portion is formed, thus achieving good cleanability.

Recycling Device

Any known recycling device can be suitably selected and used as the recycling device.

Control Device

The control device controls the behaviors of each device mentioned above. The control device is not particularly limited and can be suitably selected to suit to a particular application as long as it can control the behaviors of each device. Specific examples include, but are not limited to, a sequencer and a computer.

The image forming apparatus relating to the present embodiment forms images using the toner of the present embodiment. The toner has thus excellent low temperature fixability and color reproducibility, so that the image forming apparatus thus can produce quality images.

Image Forming Method

The image forming method relating to the present embodiment includes forming a latent electrostatic image on a latent electrostatic image bearer, developing the latent electrostatic image formed on the latent electrostatic image bearer, and other optional processes. The image forming method can be suitably executed with an image forming apparatus. The latent electrostatic image can be suitably executed with the latent electrostatic image forming device. The developing a latent electrostatic image can be suitably executed with the developing device. The other optional processes can be suitably executed with the corresponding other optional devices.

In addition to the latent electrostatic image forming and the latent electrostatic image developing, the image forming method of the present embodiment more preferably includes a transferring a toner image to a printing medium and fixing the visible image transferred to the printing medium.

In the developing, the toner relating to the present embodiment is used. Preferably, the toner relating to the present embodiment is used in the image forming method. Toner images can be formed with a developing agent containing the toner and another optional component such as a carrier.

Latent electrostatic images are formed on the latent electrostatic image bearer in the latent electrostatic image forming. The latent electrostatic image forming includes charging the surface of the latent electrostatic image bearer and irradiating the charged surface with beams of light to form a latent electrostatic image. The charging is conducted by applying a bias to the image bearer's surface with the charger, for example. The irradiation is conducted by irradiating the surface of the latent electrostatic image bearer with an irradiator according to image information. Latent electrostatic images are formed by, for example, uniformly charging the surface of a latent electrostatic image bearer and irradiating the surface according to the obtained image information using a latent electrostatic image forming device.

In the developing, visible images are formed by sequentially developing a latent electrostatic image with multiple color toners. The visible image is formed by, for example, developing the latent electrostatic image with the toner with the developing device.

In the developing unit, for example, the toner and the carrier are mixed and stirred to triboelectrically charge the toner due to the friction therebetween. The toner is held on the surface of the rotating magnet roller, forming a magnet brush like a filament. Since the magnet roller is disposed near the latent electrostatic image bearer (photoconductor), some of the toner forming the magnet brush borne on the surface of the magnet roller is transferred to the surface of the latent electrostatic image bearer by the force of the electric attraction. As a result, the latent electrostatic image is developed with the toner and rendered visible with the toner on the surface of the latent electrostatic image bearer (photoconductor).

In the transferring, the visible image is transferred to a printing medium. In the transferring, it is preferable to use an intermediate transfer body. The visible image is primarily transferred to an intermediate transfer body and then secondarily transferred to a printing medium.

More preferably, the transferring includes: transferring a visible image that is developed with two or more color toners, preferably full color toners, to an intermediate transfer body to form a complex transferred image; and secondarily transferring the complex transferred image to a printing medium. In the case that an image secondarily transferred to a printing medium is a color image formed of multiple color toners, it is possible to have a configuration in which each color toner image is sequentially overlapped on the intermediate transfer body to form an image thereon, which is secondarily transferred once to a printing medium from the intermediate transfer body.

The transferring is conducted by, for example, charging the latent electrostatic image bearer (photoconductor) using a transfer charger of the transfer device.

In the fixing, the visible image transferred onto the printing medium is fixed with a fixing device. Fixing can be conducted every time each color toner image is transferred or after a multi-color overlapped image is transferred once.

The image forming method may optionally furthermore include other optional processes such as discharging, cleaning, and recycling.

In the discharging, a discharging device applies a discharging bias to the latent electrostatic image bearer.

In the cleaning, toner remaining on the surface of a latent electrostatic image bearer is removed, which can be suitably conducted with a cleaner.

In the recycling, the toner removed in the cleaning is returned to the developing device for recycle use. This recycling can be suitably conducted by a recycling device.

The image forming method relating to the present embodiment executes forming images using the toner of the present embodiment. The toner has excellent low temperature fixability and color reproducibility, so that quality images can be produced by this image forming method.

Embodiment of Image Forming Apparatus

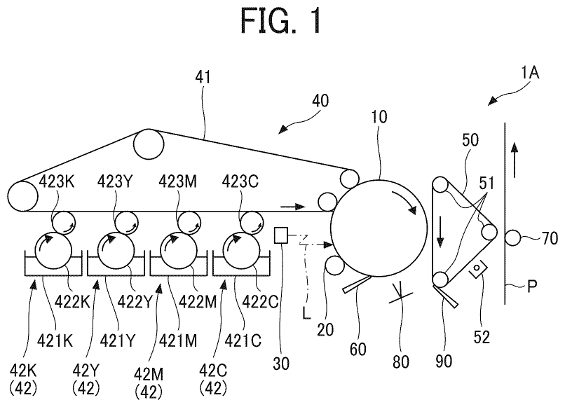

An aspect of the image forming device relating to the present embodiment is described with reference to FIG. 1. FIG. 1 is a diagram illustrating a schematic configuration of the image forming apparatus of the present embodiment. As illustrated in FIG. 1, an image forming apparatus 1A includes a drum photoconductor 10 as a latent electrostatic image bearer, a charging roller 20 as a charging device, an irradiator 30 as an irradiating device, a developing unit 40 as a developing device, an intermediate transfer body (intermediate transfer belt) 50, a cleaner 60 as a cleaning device, a transfer roller 70 as a transfer device, a discharging lamp 80 as a discharging device, and an intermediate transfer body cleaner 90.

The intermediate transfer body 50 is an endless belt stretched over three rollers 51 disposed inside. It is designed to move in the direction indicated by an arrow in FIG. 1. The three rollers 51 partially serves as a transfer bias roller to apply a transfer bias (primary transfer bias) to the intermediate transfer body 50. Around the intermediate transfer body 50 is disposed the intermediate transfer body cleaner 90. In addition, the transfer roller 70 is disposed near facing the intermediate transfer body 50. The transfer roller 70 applies a transfer bias (secondary transfer bias) to the intermediate transfer body 50 to secondarily transfer the developed toner image to a transfer sheet P. Around the intermediate transfer body 50, a corona charger 52 for applying charges to the toner image on the intermediate transfer body 50 is disposed between the contact portion of the drum photoconductor 10 and the intermediate transfer body 50 and the contact portion of the intermediate transfer body 50 and the transfer sheet P along the rotation direction of the intermediate transfer body 50.

The developing unit 40 includes a developing belt 41 as a developing agent bearer and a developing unit 42 disposed around the developing belt 41.

The developing belt 41 is an endless belt stretched over multiple belt rollers and moves in the direction indicated by an arrow in FIG. 1. Furthermore, the developing belt 41 is partially in contact with the drum photoconductor 10.

The developing unit 42 includes a black (Bk) developing unit 42K, a yellow (Y) developing unit 42Y, a magenta (M) developing unit 42M, and a cyan (C) developing unit 42C.

The black developing unit 42K includes a developing agent accommodating unit 421K, a developing agent supplying roller 422K, and a developing roller (developing agent bearer) 423K. The yellow developing unit 42Y includes a developing agent accommodating unit 421Y, a developing agent supplying roller 422Y, and a developing roller 423Y. The magenta developing unit 42M includes a developing agent accommodating unit 421M, a developing agent supplying roller 422M, and a developing roller 423M. The cyan developing unit 42C includes a developing agent accommodating unit 421C, a developing agent supplying roller 422C, and a developing roller 423C.

The method of forming images using the image forming apparatus 1A is described next. First, after the charging roller 20 charges the surface of the drum photoconductor 10, the irradiator 30 irradiates the drum photoconductor 10 with the irradiation light L to form a latent electrostatic image. Next, the latent electrostatic image formed on the drum photoconductor is developed with the toner supplied from the developing unit 40, so that a toner image is formed. Moreover, the toner image formed on the drum photoconductor 10 is primarily transferred to the intermediate transfer belt 50 by a transfer bias that is applied by the roller 51. Thereafter, the toner image is secondarily transferred to the transfer sheet P fed from a paper feeder by a transfer bias applied by the transfer roller 70. After the toner image is transferred from the drum photoconductor 10 to the intermediate transfer body 50, the cleaner removes the toner remaining on the surface of the drum photoconductor 10. Then the discharging lamp 80 discharges the drum photoconductor 10. The residual toner on the intermediate transfer body 50 after transfer is removed by the intermediate transfer body cleaner 90.

After this transfer, the transfer sheet P is conveyed to a fixing unit, where the transferred toner image is fixed on the transfer sheet P.

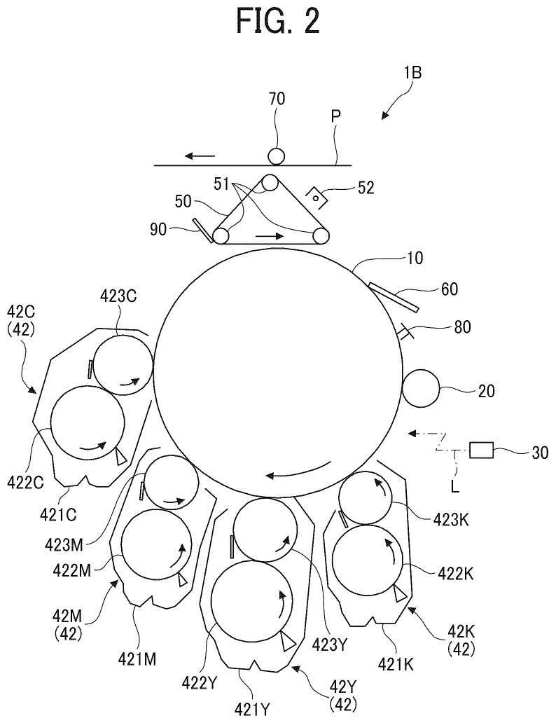

FIG. 2 is a diagram illustrating a schematic configuration of another example of the image forming apparatus of the present embodiment. As illustrated in FIG. 2, an image forming apparatus 1B has the same configuration as the image forming apparatus 1A illustrated in FIG. 1 except that the developing unit 42 (the black developing unit 42K, the yellow developing unit 42Y, the magenta developing unit 42M, and the cyan developing unit 42C) are disposed around the drum photoconductor 10 with no developing belt 41 provided.

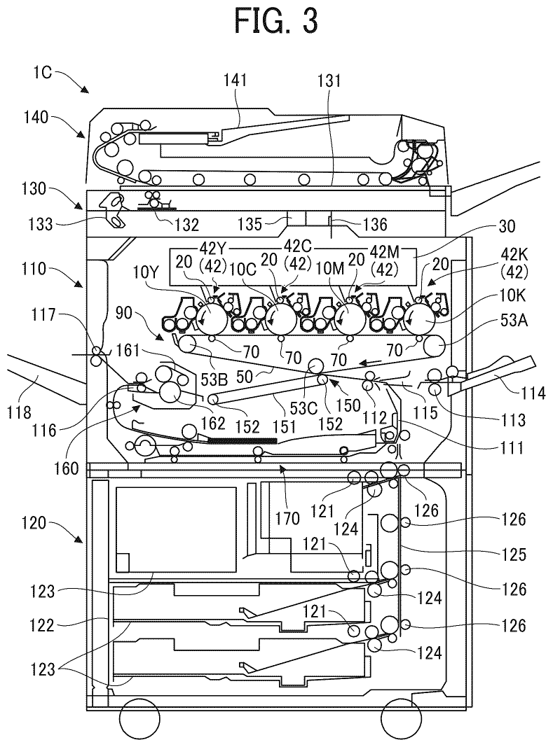

FIG. 3 is a diagram illustrating a schematic configuration of another example of the image forming apparatus of the present embodiment. As illustrated in FIG. 3, an image forming apparatus 1C is a tandem color image forming apparatus that includes a photocopying unit 110, a paper feeding table 120, a scanner 130, an automatic document feeder (ADF) 140, a secondary transfer device 150, a fixing device 160, and a sheet reversing device 170.

The photocopying unit 110 has an intermediate transfer body 50 having an endless belt form at the center of the photocopying unit 110.

The intermediate transfer body 50 is an endless belt stretched over three rollers 53A, 53B, and 53C and can move in the direction indicated by an arrow in FIG. 3. Around the roller 53B, the intermediate transfer body cleaner 90 is provided to remove toner remaining on the intermediate transfer body 50 from which the toner image is transferred to a printing medium. The developing unit 42 (the black developing unit 42K, the yellow developing unit 42Y, the magenta developing unit 42M, and the cyan developing unit 42C) as a tandem developing unit is disposed along the conveying direction in parallel facing the intermediate transfer body 50 stretched over a roller 53A and a roller 53B.

In addition, an irradiator 30 is disposed near the developing unit 42. The secondary transfer device 150 is disposed facing the developing unit 42 with the intermediate transfer body 50 between. The secondary transfer device 150 includes a secondary transfer belt 151. The secondary transfer belt 151 is an endless belt stretched over a pair of rollers 152. The printing medium conveyed on the secondary transfer belt 151 and the intermediate transfer body 50 can contact each other between the roller 53C and the roller 152.

Near the secondary transfer belt 151A is provided a fixing device 160. The fixing device 160 includes a fixing belt 161 as an endless belt stretched over a pair of roller and a pressing roller 162 disposed being pressed against the fixing belt 161.

Furthermore, around the secondary transfer belt 151 and the fixing device 160, the sheet reversing device 170 is disposed to reverse the printing medium to form images on both sides of the printing medium.

A method of forming full color images using the image forming apparatus 1C is described next.

First, a color original is set on a document table 141 in the automatic document feeder (ADF) 140. Alternatively, the automatic document feeder 140 is opened to set a color original on a contact glass 131 of the scanner 130, and then the automatic document feeder 140 is closed.

In the case that the color original is set on the automatic document feeder 140, when the start button is pressed, the color original is moved to the contact glass 131 and then the scanner 130 is immediately driven to scan the color original on the contact glass 131 with a first scanning body 132 and a second scanning body 133. In the case that an original is set on a contact glass 131, the scanner 130 is immediately driven. Then the first scanning body 132 and the second scanning body 133 start scanning. Light emitted from the first scanning body 132 is reflected at the document and the reflected light is reflected at the mirror of the second scanning body 133. Thereafter, the reflected light is received at a reading sensor 136 via an image focusing lens 135 to read the color original, the color image information on black, yellow, magenta, and cyan.

Each color image information is transmitted to each color developing unit 42 (the black developing unit 42K, the yellow developing unit 42Y, the magenta developing unit 42M, and the cyan developing unit 42C) to form each color toner image.

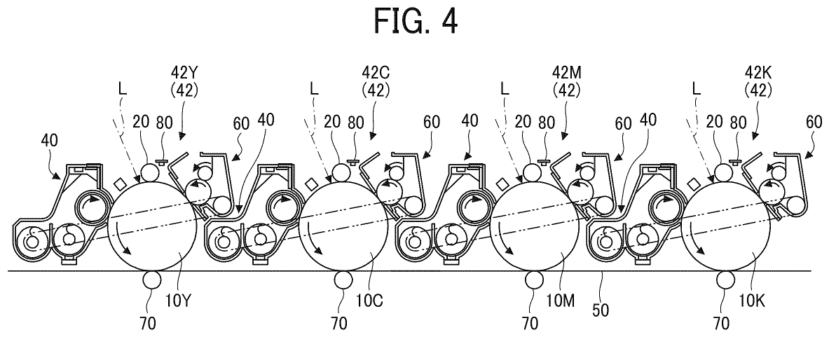

FIG. 4 is an enlarged diagram illustrating the image forming apparatus illustrated in FIG. 3. As illustrated in FIG. 4, each developing unit 42 (the black developing unit 42K, the yellow developing unit 42Y, the magenta developing unit 42M, and the cyan developing unit 42C) includes the drum photoconductor 10 (a drum photoconductor 10K for black, a drum photoconductor 10Y for yellow, a drum photoconductor 10M for magenta, and a drum photoconductor 10C for cyan), the charging roller 20 for uniformly charging the drum photoconductor10, the irradiator 30 for irradiating the drum photoconductor 10 with the irradiation light L based on each color image information to form each color latent electrostatic image on the drum photoconductor 10, the developing unit 40 for developing the latent electrostatic image with each color developing agent to form each color toner image, a transfer charger 62 for transferring each color toner image onto the intermediate transfer body 50, the cleaner 60, and the discharging lamp 80.

Each color toner image formed with the developing unit 42 (the black developing unit 42K, the yellow developing unit 42Y, the magenta developing unit 42M, and the cyan developing unit 42C) is sequentially and primarily transferred to the intermediate transfer body 50 which is moving while being stretched over the rollers 53A, 53B, and 53C. Then each color toner image is overlapped on the intermediate transfer body 50 to form a composite color image (color transfer image).

At the paper feeding table 120, one of feeding rollers 121 is selectively rotated to feed a printing medium from one of medium feeding cassettes 123 stacked in a medium bank 122.

The printing medium is separated by a separating roller 124 one by one to a medium feeding path 125. The printing medium is guided by a conveying rollers 126 to a medium feeding path 111 in the photocopying unit 110 and halted at registration roller 112. Alternatively, a manual feeding roller 113 is rotated to bring up the printing medium on a bypass tray 114. The printing media are separated one by one with the manual feeding roller 113, conveyed to a manual medium feeding path 115, and also halted at the registration roller 112.

The registration roller 112 is generally grounded but a bias can be applied thereto to remove impurities such as paper dust on the printing medium.

The registration roller 112 is rotated in synchronization with the complex toner image (color transfer image) on the intermediate transfer body 50 to send the printing medium (sheet) between the intermediate transfer body 50 and the secondary transfer belt 151, where the complex toner image is secondarily transferred to the printing medium. The intermediate transfer body cleaner 90 removes the toner remaining on the intermediate transfer body 50 from which the complex toner image (color transfer image) is transferred.

The printing medium to which the complex toner image is transferred is conveyed by the secondary transfer belt 151. Thereafter, the fixing device 160 fixes the complex toner image on the printing medium.

Thereafter, the conveyor path is switched by a switching claw 116 to eject the printing medium to an ejection tray 118 by an ejection roller 117. Alternatively, after the switching claw 116 switches the conveyor path, the printing medium is reversed by the sheet reversing device 170 and guided to the secondary transfer belt 151 again. After another image is formed on the reverse side of the printing medium, the printing medium is ejected to the ejection tray 118 by the ejection roller 117.

Aspect of Process Cartridge

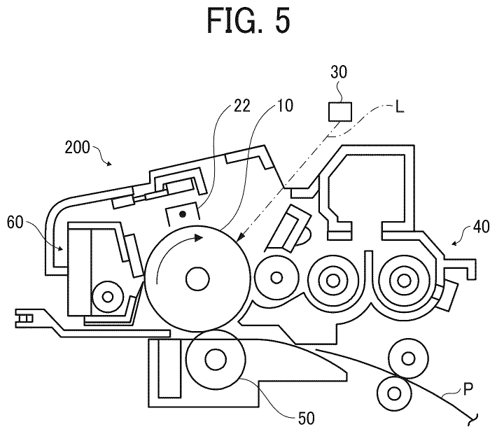

An aspect of the process cartridge relating to the present embodiment is described with reference to FIG. 5. FIG. 5 is a diagram illustrating an example of the process cartridge of the present embodiment. As illustrated in FIG. 5, a process cartridge 200 includes the drum photoconductor 10, a corona charger 22 as a charging device, the developing unit 40, the cleaner 60, and the transfer roller 70. In FIG. 5, P represents a printing medium and L represents an irradiation light.

Some embodiments of the present disclosure are described above, these embodiments are described for illustration purpose only, and the present invention is not limited thereto. These embodiments can be enforced in other forms and various combinations, omissions, replacement, and modifications can be made within the scope of the effect of the present invention. Such embodiments and variations are within the scope and effect of the present invention and are included in the invention described in the scope of the claims and their equivalents.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples and Comparative Examples but are not limited thereto.

### Synthesis of Non-Crystalline Polyester Resin 1

A total of 562 parts by mass of an adduct of bisphenol A with 2 mols of ethylene oxide, 75 parts by mass of bisphenol A with 2 mols of propylene oxide, 87 parts by mass of bisphenol A with 3 mols of propylene oxide, 143 parts by mass of terephthalic acid, 126 parts by mass of adipic acid, and 2 parts by mass of dibutyl tin oxide were placed in a reaction container equipped with a condenser, a stirrer, and a nitrogen introducing tube. Thereafter, the mixture in the reaction container was allowed to react at 230 degrees C. at a normal pressure for eight hours followed by reaction under a reduced pressure of 10 to 15 mmHg for five hours. A total of 69 parts by mass of trimellitic anhydride was placed in the reaction container to allow reaction at 180 degrees C. at a normal pressure for two hours to obtain a non-crystalline polyester resin 1.

### Preparation of Pigment Master Batch 1

The non-crystalline polyester resin 1 and Pigment Red 269 were preliminarily mixed at a ratio of 1:1 with a Henschel Mixer (FM20B, manufactured by Mitsui Miike Chemical Engineering Machinery) followed by melt-kneading at 130 degrees C. with a twin-shaft kneading machine (PCM-30, manufactured by Ikegai Corporation). The kneaded matter obtained was rolled to a thickness of 2.7 mm with a roller followed by cooling down to room temperature with a belt cooler. Then the cooled matter was coarsely-pulverized with a hammer mill to 200 to 300 μm to obtain a pigment master batch 1.

### Manufacturing of Prepolymer 1

3-methyl-1,5-pentane diol as a diol component, terephthalic acid/adipic acid at a molar ratio of 55:45 as a dicarboxylic acid, trimethylol propane at 1.0 mol percent to the entire of the monomers, and trimethylol anhydride at 0.5 mol percent to the entire of the monomers were placed in a reaction container equipped with a condenser, a stirrer, and a nitrogen introducing tube to achieve a molar ratio (OH/COOH) of hydroxyl group to carboxylic acid at 1.5. Moreover, tetrabutyl orthotitanate as a condensation catalyst was placed at 1,000 ppm to the entire of the monomers in the reaction container. The mixture obtained was heated to 200 degrees C. in a nitrogen atmosphere in two hours followed by heating to 230 degrees C. in another two hours and allowing to react for three hours while produced water was evaporated. Thereafter, the resulting substance was allowed to react with a reduced pressure of 5 to 15 mmHg for five hours to obtain an intermediate polyester 1 having a weight average molecular weight of 18,000.

The intermediate polyester 1 and isophorone diisocyanate (IPDI) were placed in a reaction chamber equipped with a condenser, a stirrer, and a nitrogen introducing tube at a molar ratio (NCO/OH) of isocyanate group in IPDI to hydroxyl group in the intermediate polyester 1 at 2.0:1.0. Ethyl acetate was added to dissolve the substance in the chamber to obtain a 50 percent ethyl acetate solution. Thereafter, the solution was heated to 80 degrees C. to allow reaction for five hours in a nitrogen atmosphere to obtain an ethyl acetate solution of the prepolymer 1 of polyester resin A as a reactive precursor.

### Manufacturing of Prepolymer 2

1,6-hexane diol as a diol component, terephthalic acid/adipic acid having a molar ratio of 55:45 as a dicarboxylic acid, trimethylol propane at 1.0 mol percent to the entire of the monomers, and trimethylol anhydride at 0.5 mol percent to the entire of the monomers at a molar ratio (OH/COOH) were placed in a reaction container equipped with a condenser, a stirrer, and a nitrogen introducing tube to achieve a molar ratio (OH/COOH) of hydroxyl group to carboxylic acid at 1.5. Moreover, tetrabutyl orthotitanate as a condensation catalyst was placed at 1,000 ppm to the entire of the monomers in the reaction container. The mixture obtained was heated to 200 degrees C. in a nitrogen atmosphere in two hours followed by heating to 230 degrees C. in another two hours and allowing to react for three hours while produced water was evaporated. Thereafter, the resulting substance was allowed to react with a reduced pressure of 5 to 15 mmHg for five hours to obtain an intermediate polyester 2 having a weight average molecular weight of 18,000.

The intermediate polyester 2 and isophorone diisocyanate (IPDI) were placed in a reaction chamber equipped with a condenser, a stirrer, and a nitrogen introducing tube at a molar ratio (NCO/OH) of isocyanate group in IPDI to hydroxyl group in the intermediate polyester 2 at 2.0:1.0. Ethyl acetate was added to dissolve the substance in the chamber to obtain a 50 percent ethyl acetate solution. Thereafter, the solution was heated to 80 degrees C. to allow reaction for five hours in a nitrogen atmosphere to obtain an ethyl acetate solution of the prepolymer 2 as a reactive precursor of the polyester resin A.

### Synthesis of Crystalline Polyester Resin 1

1,6-hexane diol and sebacic acid were placed in a 5L four-necked flask equipped with a nitrogen introducing tube, a dehydration tube, a stirrer, and a thermocouples to achieve a ratio of OH group to COOH group at 1:1. Water was flown out together with 500 ppm titanium tetraisopropoxide to the mass of the material to allow reaction followed by heating to 235 degrees C. in the end for one-hour reaction. Thereafter, the reaction was allowed to continue for six hours under a reduced pressure of 10 mmHg or less. Thereafter, the temperature was set at 185 degrees C. and trimellitic anhydride was added to achieve a molar ratio to COOH group of 0.053 followed by two-hour reaction during stirring to obtain a crystalline polyester resin 1.

### Preparation of Liquid Dispersion 1 of Crystalline Polyester Resin

A total of 55 parts by mass of the crystalline polyester resin 1, 35 parts by mass of methylethyl ketone, and 10 parts by mass of 2-propyl alcohol were placed in a four necked flask. Thereafter, the mixture was heated and stirred at the melting point of the crystalline polyester resin 1 to dissolve the crystalline polyester resin 1. Sequentially, 28 percent by mass ammonium aqueous water was added to achieve a neutralization ratio of 200 percent. The neutralization ratio was calculated based on the acid value of the crystalline polyester resin. Moreover, 130 parts by mass of deionized water was slowly added to conduct phase inversion emulsification followed by solvent removal. Thereafter, deionized water was added to adjust the concentration of the solid portion of the crystalline polyester resin 1 to 25 percent by mass to obtain a liquid dispersion 1 of crystalline polyester resin as a binder resin dispersion for resin particle (toner).

### Preparation of Liquid Dispersion 1 of Wax

A total of 180 parts of ester wax (WE-11, synthetic wax of plant-derived monomer, melting point of 67 degrees C., manufactured by NOF CORPORATION) and 17 parts of anionic surfactant (NEOGEN SC, sodium dodecylbenzenesulfonate, manufactured by DKS Co., Ltd.) were added to 720 parts of deionized water. The resulting mixture was subjected to dispersion treatment with a homogenizer to obtain liquid dispersion 1 of wax while being heated to 90 degrees C.

### Manufacturing of Resin Particle

### Example 1

### Preparation of Oil Phase

The liquid dispersion 1 of wax (50 parts by mass), the non-crystalline polyester resin 1 (8,000 parts by mass), the crystalline polyester resin liquid dispersion 1 (50 parts by mass), the pigment master batch 1 (50 parts by mass), the prepolymer 1 (10 parts by mass) were placed in a container followed by mixing with a TK homomixer, manufactured by PRIMIX Corporation at 5,000 rpm for 60 minutes to obtain an oil phase 1. The number of parts by mass mentioned above represents the solid portion in each raw material.

### Preparation of Aqueous Phase

A total of 990 parts by mass of water, 20 parts by mass of sodium dodecyl sulfate, and 90 parts by mass of ethyl acetate were mixed and stirred to obtain a milky white liquid. This liquid was determined as aqueous phase 1.

Emulsification

A total of 20 parts of 28 percent ammonium water was added to 700 parts of the oil phase 1 while being stirred with a TK homomixer at a rate of rotation of 8,000 rpm. After mixing for 10 minutes, 1200 parts of aqueous phase 1 was slowly added dropwise to the liquid mixture to obtain emulsified slurry 1.

Solvent Removal

The emulsified slurry 1 was placed in a container equipped with a stirrer and a thermometer followed by purging the emulsified slurry 1 of the solvent at 30 degrees C. for 180 minutes to obtain solvent-purged slurry 1.

Aggregation

A total of 100 parts by mass of a solution of 3 percent magnesium chloride was added dropwise to the solvent-purged slurry 1 followed by a 5-minute stirring. The resulting mixture was heated to 60 degrees C. and 50 parts by mass of sodium chloride was added when the particle diameter reached 5.0 μm to complete aggregation. Aggregated slurry 1 was thus obtained.

Fusion

The aggregated slurry 1 was stirred and heated to 70 degrees C. The heated and aggregated slurry 1 was cooled down when the average circularity reached 0.957. The resin particle liquid dispersion (slurry dispersion) 1 was thus obtained. The average circularity was measured by a wet-process flow type particle size/form analyzer (FPIA, manufactured by SYSMEX CORPORATION).

Annealing, Rinsing, and Drying

The resin particle liquid dispersion 1 was stored at 45 degrees C. for 10 hours followed by filtering with a reduced pressure and rinsing and drying in the following manner.

1. A total of 100 parts by mass of deionized water was added to the filtered cake obtaiend and the mixture was mixed with a TK HOMOMIXER at 12,000 rpm for 10 minutes followed by filtering;
2. A total of 900 parts by mass of deionized water was added to the filtered cake of the 1 and the resulting substance was mixed with a TK HOMOMIXER at a rotation number of 12,000 rpm for 30 minutes under ultrasonic vibration. The resulting mixture obtained was filtered under a reduced pressure. This operation was repeated until the electric conductivity of the liquid re-slurry was not greater than 10 μC/cm. Thus, a filtered cake 1 was obtained. The obtained filtered cake 1 was dried with a circulation dryer at 45 degrees C. for 72 hours. The dried cake obtained was sieved with a screen having an opening of 75 μm to obtain colored resin particle 1.

Adding External Additive

A total of 2.5 parts by mass of inorganic fine particles CAB-I-SIL® TS530, manufactured by Cabot Corporation), was added to 100 parts of the colored resin particle 1 followed by mixing with a Henschel mixer at 40 m/s for 10 minutes to prepare resin particles.

Using a dynamic viscoelasticity measuring device (rheometer, ARES, manufactured by TA Instruments), the resin particle was subjected to frequency sweep under the condition of an amount of strain of 0.1 percent in the mode for controlling amount of strain. The obtained minimum loss tangent δ at an angular velocity of from 0.1 to 100 rad/s was 2.2.

### Example 2

The prescription of the prepolymer 1 used in Preparation of Oil Phase in Example 1 was changed to 5 parts by mass and the aggregated salt solution in Aggregation and Fusion in Example 1 was changed from 3 percent magnesium sulfate solution to 3 percent magnesium chloride solution. Resin particles were prepared in the same manner as in Example 1 except the above.

Using a dynamic viscoelasticity measuring device (rheometer, ARES, manufactured by TA Instruments), the resin particle was subjected to frequency sweep under the condition of an amount of strain of 0.1 percent in the mode for controlling amount of strain. The obtained minimum loss tangent δ at an angular velocity of from 0.1 to 100 rad/s was 2.1.

### Example 3

The prepolymer 1 used in Preparation of Oil Phase in Example 1 was changed to the prepolymer 2 and the aggregated salt solution in Aggregation and Fusion in Example 1 was changed from 3 percent magnesium sulfate solution to 3 percent calcium chloride solution. Resin particles were prepared in the same manner as in Example 1 except the above.

Using a dynamic viscoelasticity measuring device (rheometer, ARES, manufactured by TA Instruments), the resin particle was subjected to frequency sweep under the condition of an amount of strain of 0.1 percent in the mode for controlling amount of strain. The obtained minimum loss tangent δ at an angular velocity of from 0.1 to 100 rad/s was 2.0.

### Example 4

The prescription of the prepolymer 2 used in Preparation of Oil Phase in Example 3 was changed from 10 parts by mass to 5 parts by mass and the aggregated salt solution in Aggregation and Fusion was changed from 3 percent calcium chloride solution to 3 percent aluminum sulfate solution. Resin particles were prepared in the same manner as in Example 3 except the above.

Using a dynamic viscoelasticity measuring device (rheometer, ARES, manufactured by TA Instruments), the resin particle was subjected to frequency sweep under the condition of an amount of strain of 0.1 percent in the mode for controlling amount of strain. The obtained minimum loss tangent δ at an angular velocity of from 0.1 to 100 rad/s was 1.8.

### Example 5

Resin particles were prepared in the same manner as in Example 1 except that the prescription of the prepolymer 1 used in Preparation of Oil Phase in Example 1 was changed to 12 parts by mass.

### Comparative Example 1

Resin particles were prepared in the same manner as in Example 1 except that the prepolymer was not used in Preparation of Oil Phase in Example 1.

Using a dynamic viscoelasticity measuring device (rheometer, ARES, manufactured by TA Instruments), the resin particle was subjected to frequency sweep under the condition of an amount of strain of 0.1 percent in the mode for controlling amount of strain. The obtained minimum loss tangent δ at an angular velocity of from 0.1 to 100 rad/s was 1.7.

### Comparative Example 2

### Preparation of Aqueous Phase

A total of 963 parts by mass of water, 37 parts by mass of aqueous solution of sodium dodecyldiphenyl etherdisulfonate (EREMINOR MON-7, manufactured by Sanyo Chemical Industries, Ltd.) at 48.3 percent, and 90 parts by mass of ethyl acetate were mixed and stirred to obtain milk white liquid. This liquid was determined as aqueous phase 1.

### Synthesis of Ketimine Compound

A total of 170 parts by mass of isophoronediamine and 75 parts of methylethyl ketone were placed in a reaction container equipped with a stirrer and a thermometer to allow reaction at 45 degrees C. for five and a half hours to obtain a ketimine compound.

### Preparation of Oil Phase

A total of 120 parts by mass of the liquid dispersion 1 of wax, 446 parts by mass of liquid dispersion 1 of crystalline polyester resin, and 1,894 pars by mass of ethyl acetate were placed in a container equipped with a stirrer and a thermometer. The system was heated to degrees C. and maintained as it was at 80 degrees C. for five hours and then cooled down to degrees C. in one hour. Next, 250 parts of cyan pigment (C. I. Pigment blue 15:3) and 1,000 parts of ethyl acetate were placed in the container followed by mixing for one hour to obtain a raw material solution.

Emulsification and Solvent Removal

A total of 375 parts by mass of the raw material solution, 500 parts by mass of the prepolymer 1, and 15 parts of the ketimine compound were placed in a container and mixed using a TK HOMOMIXER (manufactured by Tokushu Kika Kogyo Co., Ltd.) at 5,000 rpm for five minutes. Thereafter, 1,200 parts by mass of the aqueous phase 1 was added into the container. The mixture was mixed with the TK HOMOMIXER at 10,000 rpm for 1.5 hours to obtain an emulsified slurry 1.

The emulsified slurry 1 was placed in a container equipped with a stirrer and a thermometer followed by removing the solvent at 30 degrees C. for 8 hours. Subsequent to annealing by leaving at 30 degrees C. for 10 hours, the obtained substance was aged at 40 degrees C. for 72 hours to obtain a slurry dispersion 1.

Rinsing and Drying

A total of 100 parts by mass of the slurry dispersion 1 was filtered under a reduced pressure followed by rinsing in the following manner.

A total of 100 parts by mass of deionized water was added to the obtained filtered cake and mixed with a TK HOMOMIXER at 12,000 rpm for ten minutes followed by filtering. A total of 100 parts by mass of 10 percent hydrochloric acid was added to the obtained filtered cake and mixed with a TK HOMOMIXER at 12,000 rpm for ten minutes followed by filtering. Then 300 parts of deionized water was added to the obtained filtered cake and mixed with a TK HOMOMIXER at 12,000 rpm for 10 minutes followed by filtering. This operation was repeated twice to obtain a filtered cake 1.

The obtained filtered cake 1 was dried with a circulation dryer at 45 degrees C. for 48 hours. The dried cake obtained was sieved with a screen having an opening of 75 μm to obtain a mother particle. Then 2.20 parts by mass of a large silica (HSP 160A, manufactured by Fuso Chemical Co., Ltd.) was added to 100 parts of the obtained mother particle followed by mixing with a Henschel mixer. Moreover, 0.6 parts by mass of a small silica (R972) was admixed with the Henschel mixer followed by removing the coarse particles with a screen with an opening of 37 μm to prepare resin particles.

Using a dynamic viscoelasticity measuring device (rheometer, ARES, manufactured by TA Instruments), the resin particle was subjected to frequency sweep under the condition of an amount of strain of 0.1 percent in the mode for controlling amount of strain. The obtained minimum loss tangent δ at an angular velocity of from 0.1 to 100 rad/s was 1.0.

### Comparative Example 3

A total of 100 parts by mass of the non-crystalline polyester resin 1 and 0.5 parts by mass of the pigment master batch 1 were mixed followed by melt-kneading with a twin shaft roll mill and rolling and cooling the kneaded matter. The resulting matter was pulverized using a turbo counter jet mill pulverizer (number of rotation of rotation blade of 7,500 rpm, feeding amount of 1.2 kg/hr, manufactured by Freund Turbo Corporation) followed by air-classification using a pneumatic classifier (DS classifying device, manufactured by Nippon Pneumatic Mfg. Co., Ltd.) by swirling flow to obtain mother particles. A total of 0.9 parts by mass of a charge control agent (TN-105, manufactured by HODOGAYA CHEMICAL CO., LTD.) and 0.5 parts by mass of hydrophobic silica (H2000, manufactured by Clariant Japan K.K.) were mixed with 100 parts by mass of the obtained mother particles at 6,000 rpm for ten minutes with a Q mixer (manufactured by NIPPON COKE & ENGINEERING CO., LTD.) while being heated at a moderate temperatures to prepare resin particles.

Using a dynamic viscoelasticity measuring device (rheometer, ARES, manufactured by TA Instruments), the resin particle was subjected to frequency sweep under the condition of an amount of strain of 0.1 percent in the mode for controlling amount of strain. The obtained minimum loss tangent δ at an angular velocity of from 0.1 to 100 rad/s was 0.5.

Evaluation Method

Color reproducibiilty and low temperature fixability of the prepared resin particles in each Example and Comparative Example were evaluated in the following manner. The evaluation results are shown in Table 1.

Loss Tangent δ

The resin particle was molded to form a pellet having a diameter of 8 mm and a thickness of 2 mm. The pellet was fixed on a parallel plate having a diameter of 8 mm and stabilized at 80 degrees C. Using a dynamic viscoelasticity measuring device (rheometer, ARES, manufactured by TA Instruments), the resin particle was subjected to frequency sweep under the condition of an amount of strain of 0.1 percent in the mode for controlling amount of strain to measure the loss tangent δ at an angular velocity s of from 0.1 to 100 rad/s.

Storage Elastic Modulus G′

The resin particle was molded to form a pellet having a diameter of 8 mm and a thickness of 2 mm. The pellet was fixed on a parallel plate having a diameter of 8 mm and stabilized at 80 degrees C. Next, the storage elastic modulus G′ of the resin particle was measured with a dynamic viscoelasticity measuring device (rheometer, ARES, manufactured by TA Instruments).

Whether the storage elastic modulus G′ had a polarity at 100 degrees C. or higher and whether the storage elastic modulus G′ had a local maximum were checked.

Color Reproducibiilty

Saturation C* was measured with a colorimeter (X-Rite 939, portable spectrophotometer) under the conditions of D50 light source and 2 degree field of view. Color reproducibility was evaluated according to the following evaluation criteria.

Evaluation Criteria
A: 78 to 81
B: 75 to 78
C: 72 to 75
D: Less than 72

Low Temperature Fixability

A solid black unfixed image was formed on plain paper at 0.6 mg/cm² using the fixing unit of a color multifunction peripheral (imagio MP C4500, manufactured by Ricoh Co., Ltd.) and fixed at temperatures. The temperature below which cold offset occurred was measured to evaluate low temperature fixing according to the following evaluation criteria.
A: lower than 120 degrees C.
B: 120 to lower than 130 degrees C.
C: 130 to lower than 135 degrees C.
D: 135 degrees C. or higher

Table 1 shows the measuring results of the resin particles for use in evaluation regarding the loss tangent δ and the storage elastic modulus G′ and the evaluation results of color reproducibility and low temperature fixability.

TABLE 1

| | Prepolymer | | | | Whether storage |
|---|---|---|---|---|---|
| | | Content | | Storage | elastic modulus |
| | | (parts | Loss | elastic | G′ has |
| | | by | tangent | modulus G′ | polarity at 100⁺ |
| | Type | mass) | δ | (Pa) | degrees C. |
| Example 1 | 1 | 10 | 2.2 | 8.0 × 10³ | Yes |
| Example 2 | 1 | 5 | 2.1 | 9.0 × 10³ | Yes |
| Example 3 | 2 | 10 | 2.0 | 8.0 × 10² | No |
| Example 4 | 2 | 5 | 1.8 | 6.0 × 10² | No |
| Example 5 | 1 | 12 | 2.5 | 8.1 × 10³ | Yes |
| Comparative | None | None | 1.7 | 8.0 × 10³ | No |
| Example 1 | | | | | |
| Comparative | 1 | 10 | 1.0 | 7.0 × 10³ | No |
| Example 2 | | | | | |
| Comparative | None | None | 0.5 | 7.5 × 10³ | No |
| Example 3 | | | | | |

| | Whether storage | | |
|---|---|---|---|
| | elastic modulus | | |
| | G′ has local | Color | Low |
| | maximum at 100⁺ | repro- | temperature |
| | degrees C. | ducibiilty | fixability |
| Example 1 | Yes | A | A |
| Example 2 | No | B | B |
| Example 3 | No | B | A |
| Example 4 | No | A | B |
| Example 5 | Yes | A | A |
| Comparative | No | D | C |
| Example 1 | | | |
| Comparative | No | C | D |
| Example 2 | | | |
| Comparative | No | D | D |
| Example 3 | | | |

As seen in the results shown in Table 1, the resin particle of each Example satisfies the usage requirements regarding low temperature fixability and color reproducibility. Conversely, the resin particle of each Comparative Example does not satisfy the usage requirements of at least one of low temperature fixability and color reproducibility, causing a practical problem when in use.

Therefore, if the resin particle of each Example has a loss tangent δ of a particular value or greater at an angular velocity of from 0.1 to 100 rad/s as measured by frequency sweep at 80 degrees C., the resin particle has excellent low temperature fixability and color reproducibility, so that it can be used as quality toner.

Aspects of the present disclosure are, for example, as follows:

1. A resin particle contains a binder resin, wherein the resin particle has a loss tangent δ of 1.8 or greater at an angular velocity of from 0.1 to 100 rad/s as measured by frequency sweep at 80 degrees C.

2. The resin particle according to the 1 mentioned above, wherein the loss tangent δ has an extremum.

3. The resin particle according to the 2 mentioned above, wherein the resin particle has a storage elastic modulus G′ of 1×10³ Pa or greater and has an extremum at 100 degrees C. or higher according to dynamic viscoelasticity measuring.

4. The resin particle according to the 3 mentioned above, wherein the storage elastic modulus G′ has an extremum at 100 degrees C. or higher.

5. The resin particle according to any one of the 1 to 4 mentioned above further contains a reactive precursor.

6. The resin particle according to the 5 mentioned above, wherein the reactive precursor accounts for 1 to 20 percent by weight of the resin particle.

7. A toner contains the resin particle of any one of the 1 to 6 mentioned above.

8. A developing agent contains the toner of the 7 mentioned above and a carrier.

9. A toner accommodating unit contains the toner of the 7 mentioned above.

10. An image forming apparatus includes a latent electrostatic image bearer, a latent electrostatic image forming device to form a latent electrostatic image on the latent electrostatic image bearer, a developing device to develop the latent electrostatic image with the toner of the 7 mentioned above to form a visible image, a transfer device to transfer the visible image to a printing medium, and a fixing device to fix the visible image transferred onto the printing medium.

11. An image forming method includes forming a latent electrostatic image on a latent electrostatic image bearer, developing the latent electrostatic image formed on the latent electrostatic image bearer with the toner of the 7 mentioned above to form a visible image, transferring the visible image to a printing medium, and fixing the visible image transferred onto the printing medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A resin particle comprising:
a binder resin,
wherein the resin particle has a loss tangent δ of 1.8 or greater at angular velocity of from 0.1 to 100 rad/s as measured by frequency sweep at 80 degrees C.

2. The resin particle according to claim 1, wherein the loss tangent δ has an extremum.

3. The resin particle according to claim 2,
wherein the resin particle has:
a storage elastic modulus G′ of 1×10³ Pa or greater; and
an extremum at 100 degrees C. or higher,
according to dynamic viscoelasticity measuring.

4. The resin particle according to claim 3, wherein the storage elastic modulus G′ has an extremum at 100 degrees C. or higher.

5. The resin particle according to claim 1, further comprising a reactive precursor.

6. The resin particle according to claim 5, wherein the reactive precursor accounts for 1 to 20 percent by weight of the resin particle.

7. A toner comprising the resin particle of claim 1.

8. A developing agent comprising the toner of claim 7; and a carrier.

9. A toner accommodating unit comprising:
the toner of claim 7.

10. An image forming apparatus comprising:
a latent electrostatic image bearer;
a latent electrostatic image forming device to form a latent electrostatic image on the latent electrostatic image bearer;
a developing device to develop the latent electrostatic image with the toner of claim 7 to form a visible image; a transfer device to transfer the visible image to a printing medium; and
a fixing device to fix the visible image transferred onto the printing medium.

11. An image forming method comprising:
forming a latent electrostatic image on a latent electrostatic image bearer;
developing the latent electrostatic image formed on the latent electrostatic image bearer with the toner of claim 7 to form a visible image;
transferring the visible image to a printing medium; and
fixing the visible image transferred onto the printing medium.
